(19) United States
(12) Patent Application Publication
(10) Pub. No.: US 2012/0320585 A1
(43) Pub. Date: Dec. 20, 2012

(54) LIGHT ACTION ELEMENT MODULE, LIGHTING DEVICE, AND LIGHTING SYSTEM

(75) Inventors: Chu-Hsun Lin, Taoyuan County (TW); Hsin-Hsiang Lo, Hsinchu County (TW); Chun-Chuan Lin, Hsinchu City (TW); Chi-Shen Chang, Hsinchu County (TW); Pin-Hsien Wu, Taipei City (TW); Chia-Tsong Liu, Hsinchu County (TW)

(73) Assignee: INDUSTRIAL TECHNOLOGY RESEARCH INSTITUTE, Hsinchu (TW)

(21) Appl. No.: 13/574,247

(22) PCT Filed: Dec. 10, 2010
(86) PCT No.: PCT/CN2010/079640

§ 371 Date: Sep. 4, 2012

(30) Foreign Application Priority Data
Jan. 21, 2010 (CN) 201010002876.1

(51) Int. Cl. F21V 21/14; F21V 7/00; F21V 29/00; F21V 5/04

(52) U.S. Cl. 362/239; 362/319

(57) ABSTRACT

A light action element module, a lighting device, and a lighting system are provided. The light action element module includes N×K light action elements, wherein adjacent light action elements are connected with each other. A detachable section is disposed between every two connecting light action elements. The light action elements are for separating into a plurality of combinations of the light action elements along at least a part of the detachable sections, or the light action elements are adapted to form a combination of the light action elements without separating, so as to produce different piecing-together manners, wherein N and K are positive integers, and N is greater than or equal to 2.

### CROSS-REFERENCE TO RELATED APPLICATION

This application is a 371 of international application of PCT application serial no. PCT/CN2010/079640, filed on Dec. 10, 2010, which claims the priority benefit of China application no. 201010002876.1, filed on Jan. 21, 2010. The entirety of each of the above-mentioned patent applications is hereby incorporated by reference herein and made a part of this specification.

### TECHNICAL FIELD

The disclosure relates to an optical element, a light source, and an assembly method thereof, and more particularly to a light action element module, a lighting device, and a lighting system.

### BACKGROUND

The illumination beams emitting from conventional light sources in streetlamps such as mercury lamps, high pressure sodium lamps, or halogen lamps typically disperse in all directions from the center, and the beam shape is either about circular or elliptical. These types of roadside illumination may easily result in light damage or light pollution. Moreover, these conventional light sources have high power consumption and short lifetime.

With environmental protection awareness on the rise, the Restriction of Hazardous Substances (RoHS) directive was adopted by the European Union (EU). Starting from Jul. 1, 2006, the RoHS directive indicates that electronic and electrical equipments containing heavy metals such as lead, mercury, cadmium, and hexavalent chromium, as well as flame retardants such as polybrominated diphenyl ether and polybrominated biphenyls are restricted from entering the EU consumer market. This directive also influences other first world countries and regions to act accordingly in order to protect the safety of their living environment. Therefore, the conventional light sources containing the restricted substances are facing obsolescence.

On the other hand, new light-emitting diode (LED) light sources are becoming popular due to their long lifetime and energy saving advantages.

The illumination beam generated by streetlamps using an LED light source have long elliptical light shapes or light shapes close to rectangular shapes, and these two types of light shapes are symmetrical on the x-direction or the y-direction. Taking Taiwan R.O.C. Patent No. 1312398 “Streetlamp with Oval Light Emitting Diode” for example, for the disclosed LEDs and lens thereof, the ratio of the light shapes scattered on the long axis and the short axis of the transmission region is between 1.5 to 5. Due to the extension of the transmission region along the long axis direction, the illuminating light shape is elliptical so as to expand the illumination range of the light source module, thereby increasing the light-emitting efficiency of the streetlamp.

Taiwan R.O.C. Patent No. M364866 “Optical Lens and Light Emitting Diode Illumination Device Thereof” discloses an optical lens designed by free form surface equations, for producing even illuminance and near rectangular light shape in the illumination region, so as to satisfy specific light shape requirements. For example, streetlamp illumination requires a rectangular light shape of ratio 3:1 comparing the length of the long axis direction to the width of the short axis direction. Moreover, an LED illumination device is formed by disposing a plurality of the optical lenses on a housing, forming a coaxial lens array for use with an LED light source array, and the LED illumination device is adapted to a streetlamp, a car lamp, or a flash lamp for photography.

Moreover, U.S. Patent Application Publication No. 2008/0101063 discloses an optical unit configured by lenses of three light emitting angles, and a streetlamp formed by a plurality of the optical units. The light shapes of each type of lenses may be long ellipses, circles, and rectangles that are symmetrically distributed left to right or up and down. Although the optical units may be arbitrarily combined, but according to the spirit of the patent application, the light shape produced by the combined optical units is still symmetrically distributed left to right or up and down. Furthermore, the light shape produced by the streetlamp formed by the plurality of optical units is also symmetrically distributed left to right or up and down.

However, when illumination is needed at an intersection, any of the techniques disclosed by the foregoing applications requires installing at least four streetlamps for full illumination at the crossroads.

FIG. 1 is a schematic view of a configuration for streetlamp illumination at an intersection. As shown in FIG. 1, since a light shape 81 produced by each street lamp 80 is a long ellipse or rectangle symmetrically distributed left to right or up and down, therefore a streetlamp 80 must be respectively configured at the four directions of the crossroads in order to provide sufficient illuminance at the intersection of the crossroads.

However, configuring an additional streetlamp multiplies the installation cost and maintenance fee. Therefore, in order to lower the installation cost and maintenance fee, currently available techniques need to be reconsidered and improved, so that the light shape can satisfy specific needs and the cost can be reduced.

### SUMMARY

An embodiment of the disclosure provides a light action element module, including N×K light action elements, in which adjacent light action elements are connected, and one or more detachable section(s) is/are disposed between the light action elements. The light action elements are for selection to separate into a plurality of combinations of the light action elements along at least a part of the detachable section(s) or to form a combination of the light action elements without separating, so as to piece together at least a part of the combinations of the light action elements in different manners. N and K are positive integers, and N is greater than or equal to 2.

Another embodiment of the disclosure provides a lighting system including at least one lighting device. The lighting device includes at least one light source module and at least one combination group of light action elements. The light source module includes at least one light emitting element. The at least one combination group of light action elements is formed by at least a part of at least one light action element module, and the light action element module includes N×K light action elements, in which adjacent light action elements are connected, and one or more detachable section(s) is/are disposed between the connected light action elements. The light action elements are for selection to separate into a plurality of combinations of the light action elements along at least a part of the detachable section(s) or to form a combination of the light action elements without separating, whereby at least a part of the combinations of the light action elements are pieced together in different manners, so as to form the combination group of light action elements. N and K are positive integers, and N is greater than or equal to 2. The light action elements correspond to the light emitting elements so as to guide light emitted from the light emitting elements.

Another embodiment of the disclosure provides a lighting device, including at least one light source module, at least one combination group of light action elements, and a waterproof element. The light source module includes at least one light emitting element. The combination group of light action elements is disposed on the light source module and has a plurality of light action elements, in which the light action elements correspond to the light emitting elements, so as to guide light emitted from the light emitting elements. The waterproof element is disposed between the light source module and the combination group of light action elements, and covers at least a part of the light source module.

Another embodiment of the disclosure provides a lighting device, including at least one light emitting element and at least one light action element. The light action element is disposed on the light emitting element. The light action element corresponds to the light emitting element to guide light emitted by the light emitting element. The light action element has an asymmetric curved surface, and at least one cross-section of the light action element in an asymmetric direction is mirror-asymmetric. The light action element in the lighting device is adapted to rotate with respect to the light emitting element, so as to adjust an orientation of the asymmetric direction of the light action element.

### DESCRIPTION OF THE DRAWINGS

FIG. 1 is a schematic view of a configuration for streetlamp illumination at an intersection.

FIG. 2 is a three-dimensional exploded view of a lighting device according to an exemplary embodiment.

FIG. 3 is a partial three-dimensional exploded view of the lighting device depicted in FIG. 2.

FIG. 4A is a three-dimensional appearance view of a light action element module formed by arranged light action elements with symmetrical light shapes depicted in FIG. 2.

FIG. 4B is a light shape diagram produced after light guide by the light action element module depicted in FIG. 4A formed by arranged light action elements with symmetrical light shapes.

FIG. 5A is a three-dimensional appearance view of a light action element module formed by arranged light action elements with asymmetrical light shapes depicted in FIG. 2.

FIG. 5B is a light shape diagram produced after light guide by the light action element module depicted in FIG. 5A formed by the arranged light action elements with asymmetrical surfaces.

FIG. 6 is a schematic top view of the various types of light action element modules for being pieced together to form the arrangement of the light action element modules depicted in FIG. 2.

FIG. 7A is a schematic view of a light action element module arrangement producing a cross-shaped light shape according to an exemplary embodiment.

FIG. 7B schematically illustrates the cross-shaped light shape produced by the embodiment depicted in FIG. 7A.

FIG. 8A is a schematic view of a light action element module arrangement producing an X-shaped light shape according to an exemplary embodiment.

FIG. 8B schematically illustrates the X-shaped light shape produced by the embodiment depicted in FIG. 8A.

FIG. 9A is a schematic view of a light action element module arrangement producing a line and circle shaped light shape according to an exemplary embodiment.

FIG. 9B schematically illustrates the line and circle shaped light shape produced by the embodiment depicted in FIG. 9A.

FIG. 10A is a schematic view of a light action element module arrangement producing a cross and circle shaped light shape according to an exemplary embodiment.

FIG. 10B schematically illustrates the cross and circle shaped light shape produced by the embodiment depicted in FIG. 10A.

FIG. 11A is a schematic view of a light action element module arrangement producing a T-shaped light shape according to an exemplary embodiment.

FIG. 11B schematically illustrates the T-shaped light shape produced by the embodiment depicted in FIG. 11A.

FIG. 12A is a schematic view of a light action element module arrangement producing an L-shaped light shape according to an exemplary embodiment.

FIG. 12B schematically illustrates the L-shaped light shape produced by the embodiment depicted in FIG. 12A.

FIG. 13A is a schematic view of a light action element module arrangement producing a V-shaped light shape according to an exemplary embodiment.

FIG. 13B schematically illustrates the V-shaped light shape produced by the embodiment depicted in FIG. 13A.

FIG. 14 is a partial three-dimensional view of a light source module and a light action element in a lighting device according to another exemplary embodiment.

FIG. 15 is a schematic cross-sectional view depicting a light source module and a light action element in a lighting device according to another exemplary embodiment.

FIG. 16 is a three-dimensional view depicting a light source module and a light action element module in a lighting device according to another exemplary embodiment.

FIG. 17 is a three-dimensional view depicting a light source module in a lighting device according to another exemplary embodiment.

FIG. 18 is a schematic top view of a light action element module according to another exemplary embodiment.

FIG. 19A is a schematic top view of a light action element module according to another exemplary embodiment.

FIG. 19B is a schematic top view of a light action element module according to another exemplary embodiment.

FIG. 20A is a schematic view of an illumination from a lighting device with a symmetric light shape.

FIG. 20B is a schematic view of an illumination from a light emitting element and a light action element according to an exemplary embodiment.

FIG. 21 is a schematic cross-sectional view of the light emitting element and the light action element depicted in FIG. 20B.

FIG. 22 is a light distribution diagram generated by the light emitting element and the light action element depicted in FIG. 21.

FIG. 23A and FIG. 23B illustrate applications of the light emitting element and the light action element depicted in FIG. 21.

FIG. 24 schematically illustrates the detailed structures of the lighting device depicted in FIG. 23B.

FIG. 25 schematically illustrates other implementations of a light action element.

FIG. 26 depicts a schematic cross-sectional view and a top view of two perpendicular cross-sections of a lighting device according to an exemplary embodiment.

FIG. 27 is an exploded view of the lighting device depicted in FIG. 26.

FIG. 28 is a schematic cross-sectional view of a lighting device according to another exemplary embodiment.

FIG. 29 is a flowchart of an assembly method of a lighting device according to an exemplary embodiment.

FIG. 30 is a three-dimensional view depicting a light source module in a lighting device according to another exemplary embodiment.

FIGS. 31A and 31B are respective three-dimensional views of a lighting system at two different view angles according to an exemplary embodiment.

FIG. 32 is a three-dimensional view of a lighting system according to another exemplary embodiment.

FIGS. 33A-33C are schematic cross-sectional views of a lighting device under three different states according to another exemplary embodiment.

FIG. 34 is a schematic cross-sectional view of a lighting device according to another exemplary embodiment.

FIGS. 35A and 35B are schematic cross-sectional views of a lighting device under two different states according to another exemplary embodiment.

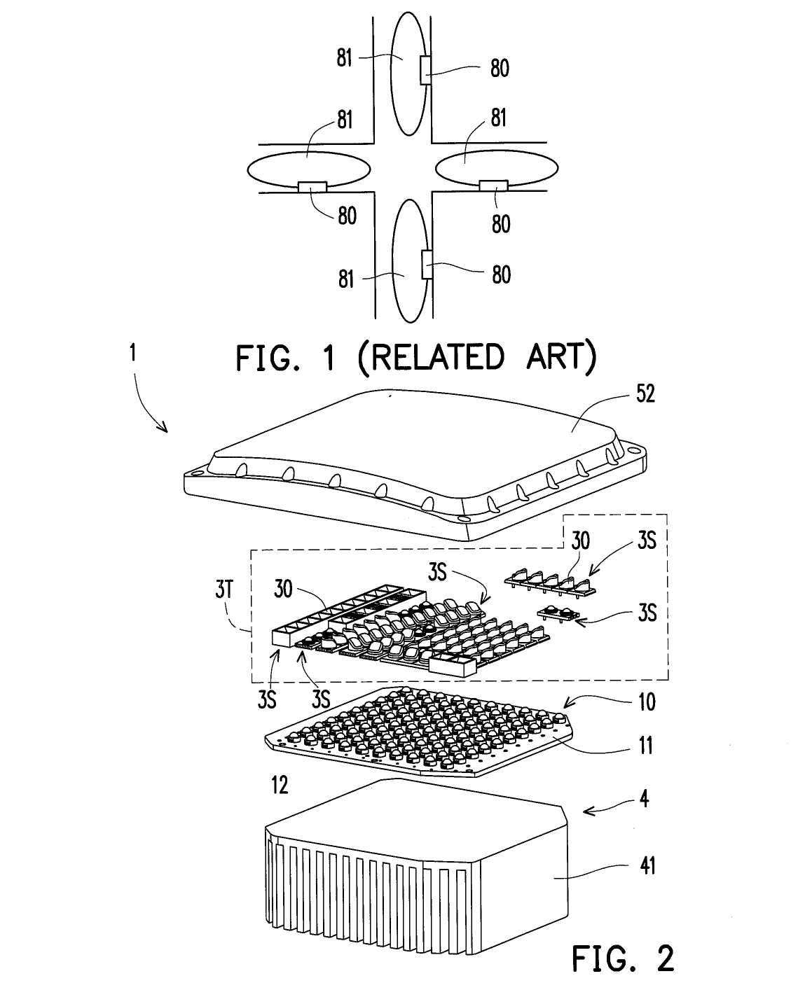

### DETAILED DESCRIPTION

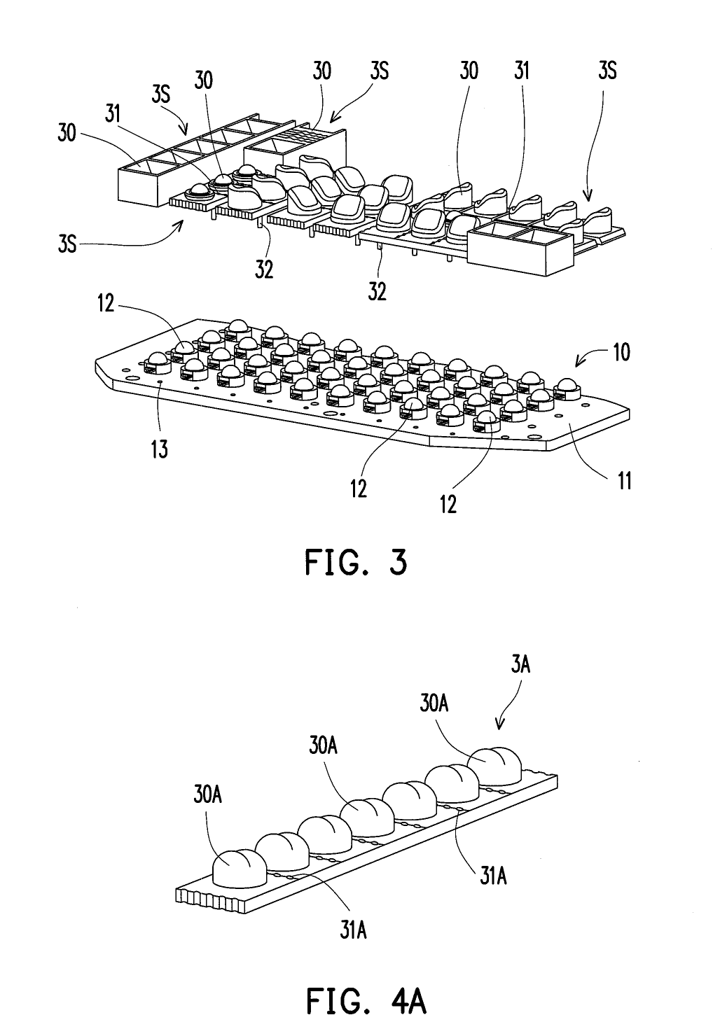

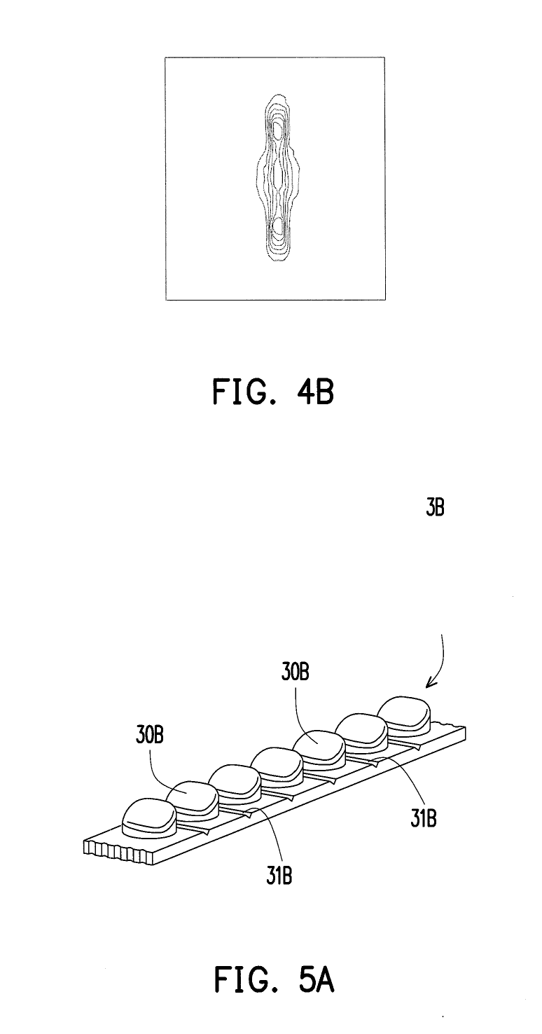

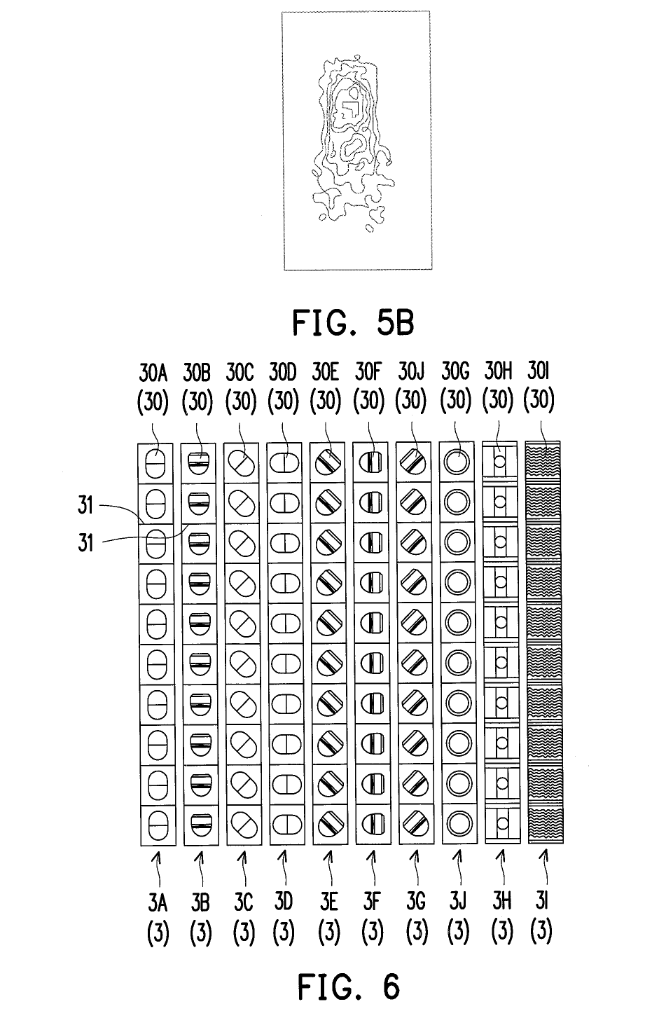

FIG. 2 is a three-dimensional exploded view of a lighting device according to an exemplary embodiment. FIG. 3 is a partial three-dimensional exploded view of the lighting device depicted in FIG. 2. FIG. 4A is a three-dimensional appearance view of a light action element module formed by arranged light action elements with symmetrical light shapes depicted in FIG. 2. FIG. 4B is a light shape diagram produced after light guide by the light action element module depicted in FIG. 4A formed by arranged light action elements with symmetrical light shapes. FIG. 5A is a three-dimensional appearance view of a light action element module formed by arranged light action elements with asymmetrical light shapes depicted in FIG. 2. FIG. 5B is a light shape diagram produced after light guide by the light action element module depicted in FIG. 5A formed by the arranged light action elements with asymmetrical light shapes. FIG. 6 is a schematic top view of the various types of light action element modules for being pieced together to form the arrangement of the light action element modules depicted in FIG. 2.

Referring to FIGS. 2-6, a lighting device 1 of the present embodiment includes at least one light source module 10 (one light source module is taken as an example in FIG. 2), at least one combination group 3T of light action elements, and a heat dissipating element 4. In the embodiment, a transparent cover 52 covers and is above the combination group 3T of light action elements, so that the lighting device 1 of the present embodiment has a waterproof function. In the present embodiment, the transparent cover 52 may have optical properties. That is to say, the transparent cover 52 may have optical structures for making an action on the light, in which the optical structures may be recessions with various shapes, protrusions with various shapes, irregular surfaces, or diffusion structures or materials inside the transparent cover. However, in other embodiments, the transparent cover 52 may not have optical properties. For example, the transparent cover 52 may have a smooth surface for light transmission that does not make a particular action on the light.

The light source module 10 includes at least one light emitting element 12 (a plurality of light emitting elements 12 are taken as an example in FIG. 2) and a carrier 11, and the light emitting elements 12 are disposed on the carrier 11. In the present embodiment, the light emitting elements 12 are arranged in array on the carrier 11. However, in other embodiments, the light emitting elements 12 may also be arranged in a staggered manner on the carrier 11. In the present embodiment, each of the light emitting elements 12 may be a light emitting diode (LED), and the carrier 11 may be a circuit board, for example. However, in other embodiments, the light emitting elements may be organic light emitting diodes (LEDs) or laser emitters. Moreover, in the present embodiment, the light emitting elements 12 may be electrically connected to the carrier 11 by welding. However, in other embodiments, the light emitting elements 12 may be connected to the carrier 11 by direct extractable insertion, so that the light emitting elements 12 are electrically connected to the carrier 11. Further details thereof are provided in the embodiment hereafter. In the present embodiment, the LEDs are white LEDs, red LEDs, green LEDs, blue LEDs, LEDs of other colors, or a combination thereof.

Each of the combination groups 3T of light action elements has at least one light action element 30. In the present embodiment, the carrier 11 has at least one first positioning part 13 respectively disposed besides each of the light emitting elements 12, and each of the light action elements 30 has at least one second positioning part 32 corresponding to the first positioning part 13. The first positioning parts 13 and the second positioning parts 32 are mutually engaging, so that the light action elements 30 are disposed across the corresponding light emitting elements 12. In the present embodiment, one of the mutually engaging first positioning part 13 and the second positioning part 32 is an inserting pin, and the other one of the mutually engaging first positioning part 13 and the second positioning part 32 is an insertion hole. The inserting pin is adapted for insertion in the corresponding insertion hole, such that the light action elements 30 achieve the effect of being fixed on the carrier 11.

The heat dissipating element 4 includes a heat sink wings 41 and is connected to the light source module 10. For example, the heat sink wings 41 are connected to a bottom surface of the carrier 11 to dissipate heat from the light source module 10. Moreover, in one embodiment, a fan may be disposed besides the heat sink wings 41, so that heat dissipated by the heat sink wings 41 can be removed through air flow.

The combination groups 3T of light action elements are formed by at least a part of at least one light action element module 3. In the present embodiment, each of the light action element modules 3 includes N×K light action elements 30, in which N and K are positive integers, and N is greater than or equal to 2. The adjacent light action elements 30 are connected, and one or more detachable section(s) 31 is/are disposed between the connected light action elements 30. The light action elements 30 are for selection to separate into a plurality of combinations 3S of light action elements along at least a part of the detachable section(s) 31 or to form a combination 3S of light action elements without separating. Therefore, at least a part of the combinations 3S of light action elements are for being pieced together in different manners (e.g., being pieced together in different manners on a surface), so as to form the combination groups 3T of the light action elements. For example, the manner for piecing together the combination 3S of light action elements depicted in FIGS. 2 and 3 involves separating the light action elements 30A-30I of the light action element modules 3A-3I into a plurality of combinations 3S of light action elements 30A-30I not all having the same quantity. Moreover, at least a part of the combinations 3S of light action elements is pieced together to form the combination group 3T of the light action elements depicted in FIGS. 2 and 3. One combination 3S of light action elements in FIG. 2 includes a row of light action elements 30, and the combination group 3T of the light action elements depicted in FIG. 2 includes an entire surface of the light action elements 30 formed by the combinations 3S of light action elements.

Referring to FIG. 4A, in one embodiment, the detachable section 31A includes a plurality of adjacent but separated holes, so that an assembler or a user may convenient to separate two adjacent light action elements 30 along the detachable sections 31A by breaking, cutting, splitting, sawing, trimming, or other suitable methods. However, in FIG. 5A, the detachable section 31B may include grooves, so that the assembler or the user may separate two adjacent light action elements 30 along the grooves by breaking, splitting, sawing, trimming, or other suitable methods. The disclosure does not limit the structure of the detachable sections, and therefore the detachable sections may have any suitable structure or shape. Alternatively, the detachable section may be a boundary between two adjacent light action elements 30, so that the detachable section have no particular structure. The user may separate two adjacent light action elements 30 along the detachable section by breaking, splitting, sawing, trimming, or other suitable methods. Alternatively, the detachable section may include a marking line (e.g. a printed marking line) to indicate the boundary between two adjacent light action elements.

The light action elements 30 corresponds to the light emitting elements 12 in order to guide the light emitted from the light emitting elements 12, and to alter the light shape of the light emitted from the light emitting elements 12. For example, light emitted by each of the light emitting elements 12 is guided by a plurality of light action elements 30. Alternatively, each of the light action elements 30 guides light emitted by a plurality of light emitting elements 12. In the present embodiment, each of the light action elements 30 guides the light emitted by a light emitting element 12, and each of the light action elements 30 is disposed directly above a light emitting element 12.

In the present embodiment, the light action elements 30 include lenses, reflective cups, diffusive covers, diffractive elements, liquid lenses, other elements capable of making an action on light, or a combination thereof, in which the lenses have symmetric light shapes or asymmetric light shapes, for example. Moreover, by changing a voltage to alter the curvature of the interface between two liquids of different refractive indices, light shape variation of the liquid lenses can be achieved.

The light action elements 30 may alter light shapes of the light emitted from the light emitting elements 12, and different types of light action elements 30 produce different effects on the light. The assembler or the user may adopt the same or different types of light action elements 30, and arrange the light action elements 30 in the same or different manners, so as to satisfy the light shape requirement.

In the present embodiment, the light action element module 3 employs 10 light action elements 30 for illustration, although the disclosure is not limited thereto. Each of the light action elements 30 may be independently used after being separated from the light action element module 3.

Each of the light action element module 3 is fabricated into an N×K shape. After the light action element module 3 is separated according to a needed quantity, combinations 3S of light action elements are formed. Alternatively, the light action element module 3 form the combination 3S of light action elements without separating. Thereafter, the combinations 3S of light action elements (including at least one of the separated combinations 3S and the not separated combinations 3S of light action elements) are combined on the carrier 11, so that the light source module 10 may cooperate with one or a plurality of the combinations 3S of light action elements. As a result, the light source module 10 cooperates with the combinations 3S of light action elements to respectively generate light shapes, and the light shapes are integrated to form a light shape of the entire lighting device.

Furthermore, in order for the lighting device 1 to have an adjustable light shape, the present embodiment may selectively adopt one type or a plurality of types of the light action element module, or adopt the combinations 3S of light action elements formed thereby to change or adjust the light shape.

The different types of the light action element module are respectively described hereafter.

Referring to FIG. 4A, the light action elements 30A depicted in the figure are lenses with symmetric light shapes. The lenses with symmetric light shapes are arranged into the light action element module 3A. The divisions between two adjacent lenses may depend on a required quantity of lenses. The lenses with symmetric light shapes depicted in FIG. 4A can generate a long rectangular light shape, as shown in FIG. 4B.

The light action elements 30B depicted in FIG. 5A are lenses with asymmetric light shapes. A plurality of the lenses with asymmetric light shapes are arranged into the light action element module 3B. The divisions between two adjacent lenses may depend on a required quantity of lenses. The light action elements 30B depicted in FIG. 5A can generate an asymmetric rectangular light shape, as shown in FIG. 5B.

Besides the aforementioned lenses with symmetric light shapes (e.g. the light action elements 30A) and the lenses with asymmetric light shapes (e.g. the light action elements 30B), different types of lenses may be combined to form the light action element module. Referring to FIG. 6, the figure depicts a schematic view of the exterior of different types of light action element modules. Besides the lenses with symmetric light shapes (e.g. the light action elements 30A) and the lenses with asymmetric light shapes (e.g. the light action elements 30B) respectively form the light action element modules 3A and 3B, the lenses with symmetric light shapes may be rotated by an angle (e.g., 45° or 90°), so as to fabricate lenses with oblique and lateral symmetric light shapes (e.g. the light action elements 30C and 30D), and respectively form the light action element modules 3C and 3D. Alternatively, the lenses with asymmetric light shapes may be rotated by an angle (e.g., 45°, 90°, or −45°), so as to fabricate lenses with oblique and lateral asymmetric light shapes (i.e. the light action elements 30E, 30F, and 30J), and respectively form the light action element modules 3E, 3F, and 3J. A typical circular lens may also be fabricated (e.g. the light action element 30G), so as to form the light action element module 3G.

Besides the aforementioned types of lenses for the light action elements 30, the light action elements 30H may also be a plurality of reflective cups forming the light action element module 3H. Alternatively, the light action elements 30I may also be a plurality of diffusive covers forming the light action element module 3I.

The light action elements are not limited to the aforementioned variations. The light action element module may also be formed by different types of light action elements.

According to the present embodiment, by using different types of light action elements to fabricate an N×K structural design of the light action element module, the light action elements may be arbitrarily separated according to the needed quantity. Therefore, the light shape produced by the lighting device can be adjusted by modifying or combining one or different types of light action elements or combinations of light action elements according to the requirements.

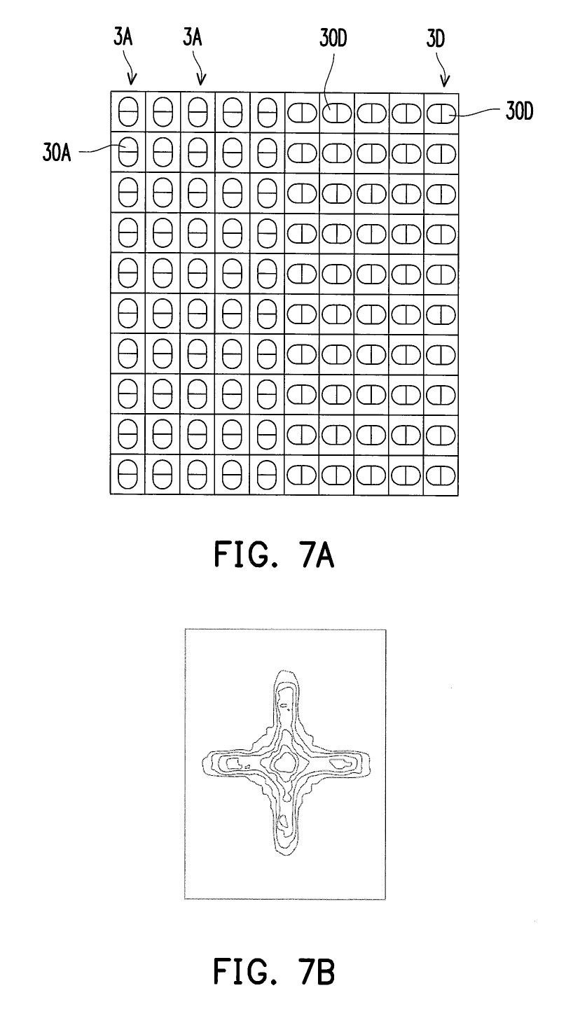

Referring to FIGS. 7A and 7B, FIG. 7A is a schematic view of a light action element module arrangement producing a cross-shaped light shape according to an exemplary embodiment. FIG. 7B schematically illustrates the cross-shaped light shape produced by the embodiment depicted in FIG. 7A. In the depicted arrangement of the light action element module in the lighting device, the five columns near the left side of FIG. 7A adopt the light action element module 3A formed by 10 lenses with vertically symmetric light shapes (e.g. the light action elements 30A), and the five columns near the right side of FIG. 7A adopt the light action element module 3D formed by 10 lenses with lateral symmetric light shapes (e.g. the light action elements 30D). Moreover, each light action element module 3A forms a combination of light action elements without separating, and each light action element module 3D forms another combination of light action elements without separating. The combinations of light action elements are pieced together to form a combination group of light action elements, for example, pieced together into an entire surface to form the combination groups of light action elements. The light action element module 3A produces a long rectangular light shape vertically, and the light action element module 3D produces a long rectangular light shape horizontally, so that the lighting device can generate the cross-shaped light shape shown in FIG. 7B.

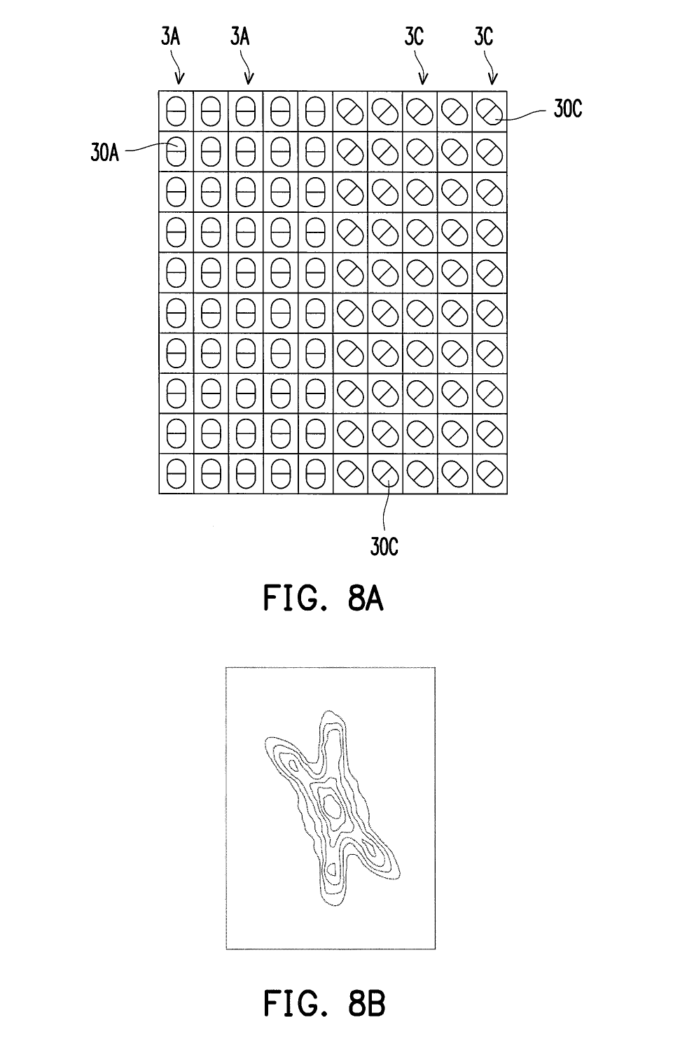

Referring to FIGS. 8A and 8B, FIG. 8A is a schematic view of a light action element module arrangement producing an X-shaped light shape according to an exemplary embodiment. FIG. 8B schematically illustrates the X-shaped light shape produced by the embodiment depicted in FIG. 8A. In the depicted arrangement of the light action element module in the lighting device, the five columns near the left side of FIG. 8A adopt the light action element module 3A formed by 10 lenses with vertically symmetric light shapes (e.g. the light action elements 30A), and the five columns near the right side of FIG. 8A adopt the light action element module 3C formed by 10 lenses with oblique symmetric light shapes (e.g. the light action elements 30C). Moreover, each light action element module 3A forms a combination of light action elements without separating, and each light action element module 3C forms another combination of light action elements without separating. The combinations of light action elements are pieced together to form combination groups of light action elements, for example, pieced together into an entire surface to form the combination groups of light action elements. The light action element module 3A produces a long rectangular light shape vertically, and the light action element module 3C produces a long rectangular light shape obliquely, so that the lighting device can generate the X-shaped light shape shown in FIG. 8B.

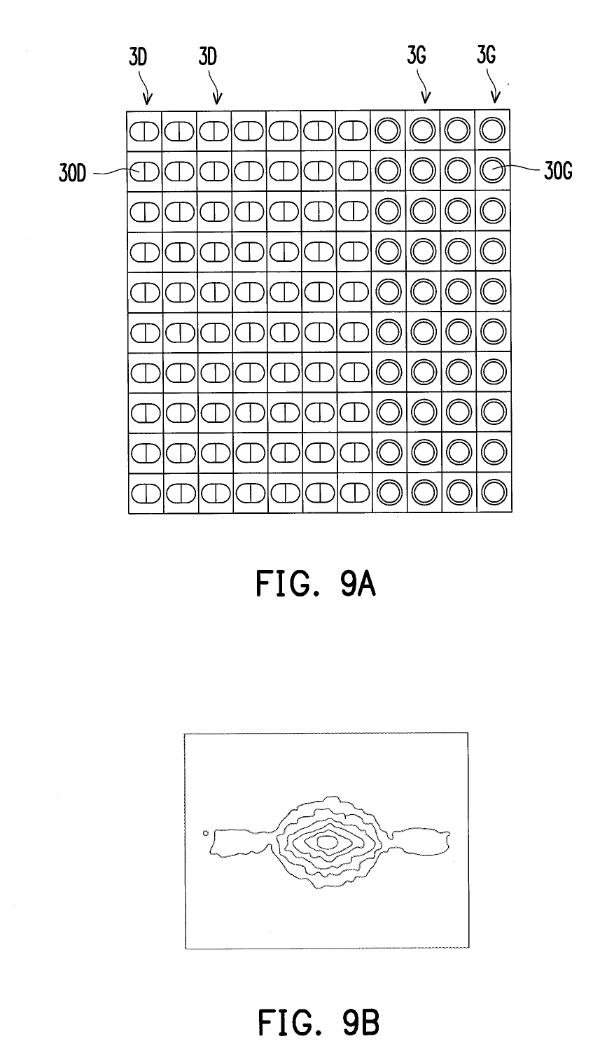

Referring to FIGS. 9A and 9B, FIG. 9A is a schematic view of a light action element module arrangement producing a line and circle shaped light shape according to an exemplary embodiment. FIG. 9B schematically illustrates the line and circle shaped light shape produced by the embodiment depicted in FIG. 9A. In the depicted arrangement of the light action element module in the lighting device, the six columns near the left side of FIG. 9A adopt the light action element module 3D formed by 10 lenses with lateral symmetric light shapes (e.g. the light action elements 30D), and the four columns near the right side of FIG. 9A adopt the light action element module 3G formed by 10 circular lenses (e.g. the light action elements 30G). Moreover, each light action element module 3D forms a combination of light action elements without separating, and each light action element module 3G forms another combination of light action elements without separating. The combinations of light action elements are pieced together to form a combination group of light action elements, for example, pieced together into an entire surface to form the combination group of light action elements. The light action element module 3D produces a long rectangular light shape horizontally, and the light action element module 3G produces a circular light shape, so that the lighting device can generate the line and circle shaped light shape shown in FIG. 9B.

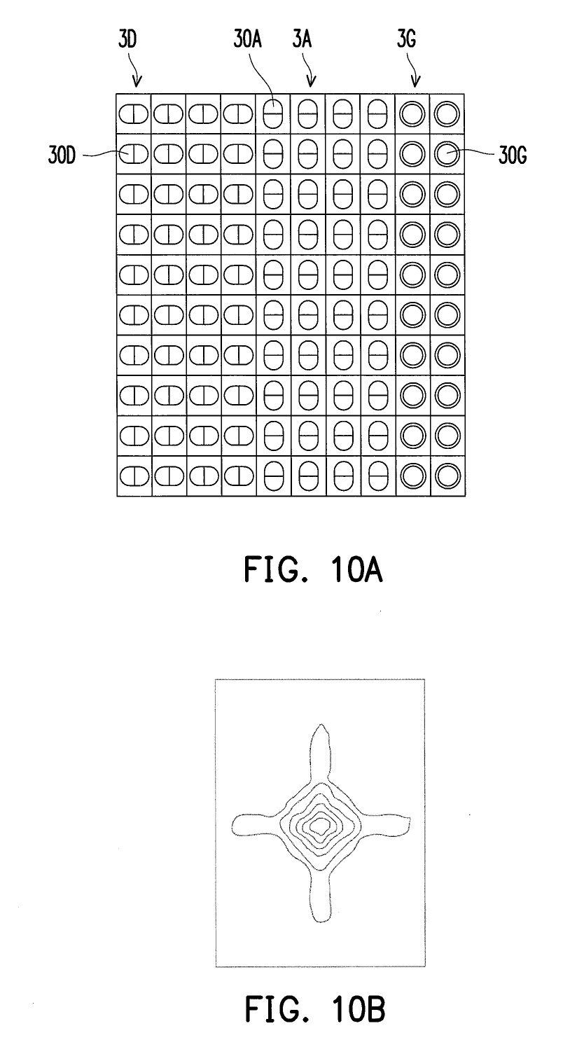

Referring to FIGS. 10A and 10B, FIG. 10A is a schematic view of a light action element module arrangement producing a cross and circle shaped light shape according to an exemplary embodiment. FIG. 10B schematically illustrates the cross and circle shaped light shape produced by the embodiment depicted in FIG. 10A. In the depicted arrangement of the light action element module in the lighting device, the four columns near the left side of FIG. 10A adopt the light action element module 3D formed by 10 lenses with lateral symmetric light shapes (e.g. the light action elements 30D), the middle four columns of FIG. 10A adopt the light action element module 3A formed by 10 lenses with vertically symmetric light shapes (e.g. the light action elements 30A), and the two columns near the right side of FIG. 10A adopt the light action element module 3G formed by 10 circular lenses (e.g. the light action elements 30G). Moreover, each light action element module 3D forms a combination of light action elements without separating, each light action element module 3A forms another combination of light action elements without separating, and each light action element module 3G forms yet another combination of light action elements without separating. The combinations of light action elements are pieced together to form a combination group of light action elements, for example, pieced together into an entire surface to form the combination groups of light action elements. The lenses with lateral symmetric light shapes (e.g. the light action elements 30D) produce a long rectangular light shape horizontally, the lenses with vertically symmetric light shapes (e.g. the light action elements 30A) produce a long rectangular light shape vertically, and the circular lenses (e.g. the light action elements 30G) produce a circular light shape, so that the lighting device can generate the cross and circle shaped beam shown in FIG. 10B.

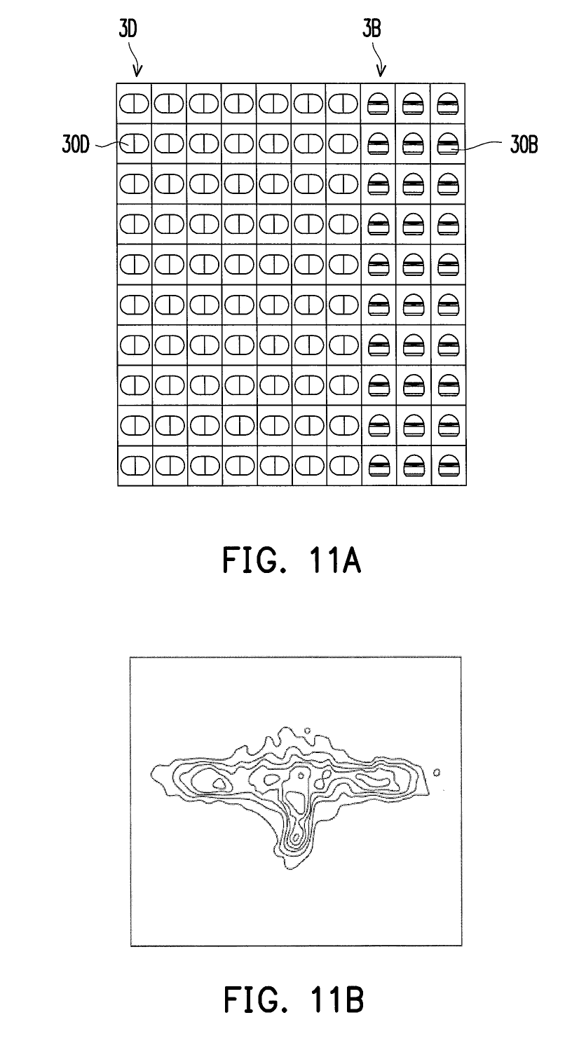

Referring to FIGS. 11A and 11B, FIG. 11A is a schematic view of a light action element module arrangement producing a T-shaped light shape according to an exemplary embodiment. FIG. 11B schematically illustrates the T-shaped light shape produced by the embodiment depicted in FIG. 11A. In the depicted arrangement of the light action element module in the lighting device, the seven columns near the left side of FIG. 11A adopt the light action element module 3D formed by 10 lenses with lateral symmetric light shapes (e.g. the light action elements 30D), and the three columns near the right side of FIG. 11A adopt the light action element module 3B formed by 10 lenses with vertically asymmetric light shapes (e.g. the light action elements 30B). Moreover, each light action element module 3D forms a combination of light action elements without separating, and each light action element module 3B forms another combination of light action elements without separating. The combinations of light action elements are pieced together to form a combination group of light action elements, for example, pieced together into an entire surface to form the combination group of light action elements. The light action element module 3D produces a long rectangular light shape horizontally, and the light action element module 3B produces an asymmetric rectangular light shape vertically, so that the lighting device can generate the T-shaped light shape shown in FIG. 11B.

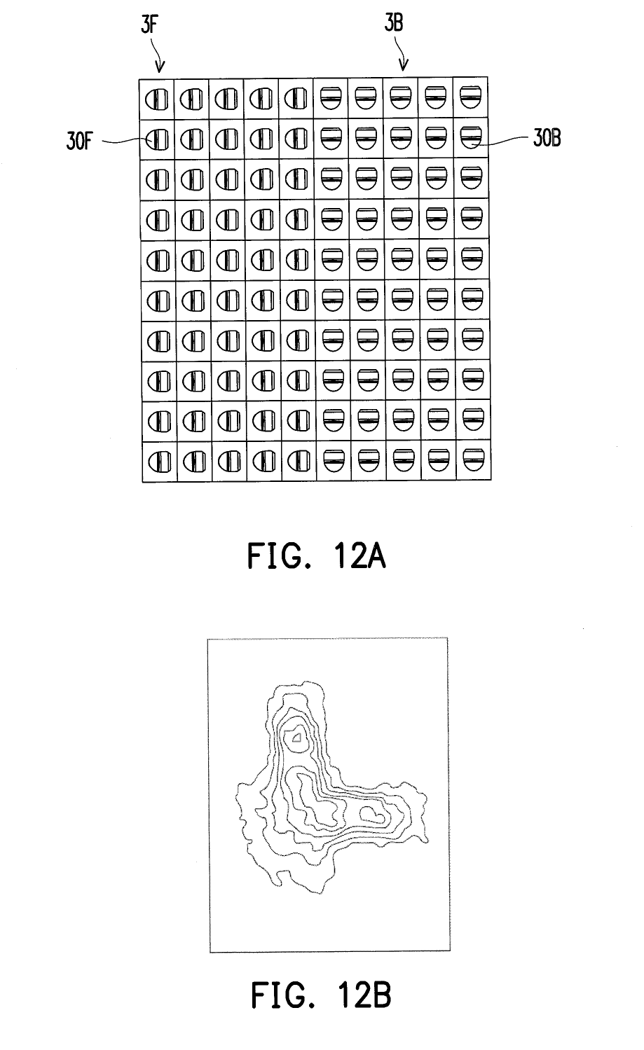

Referring to FIGS. 12A and 12B, FIG. 12A is a schematic view of a light action element module arrangement producing an L-shaped light shape according to an exemplary embodiment. FIG. 12B schematically illustrates the L-shaped light shape produced by the embodiment depicted in FIG. 12A. In the depicted arrangement of the light action element module in the lighting device, the five columns near the left side of FIG. 12A adopt the light action element module 3F formed by 10 lenses with lateral asymmetric light shapes (e.g. the light action elements 30F), and the five columns near the right side of FIG. 12A adopt the light action element module 3B formed by 10 lenses with vertically asymmetric light shapes (e.g. the light action elements 30B). Moreover, each light action element module 3F forms a combination of light action elements without separating, and each light action element module 3B forms another combination of light action elements without separating. The combinations of light action elements are pieced together to form a combination group of light action elements, for example, pieced together into an entire surface to form the combination group of light action elements. The light action element module 3F produces an asymmetric rectangular light shape horizontally, and the light action element module 3B produces an asymmetric rectangular light shape vertically, so that the lighting device can generate the L-shaped light shape shown in FIG. 12B.

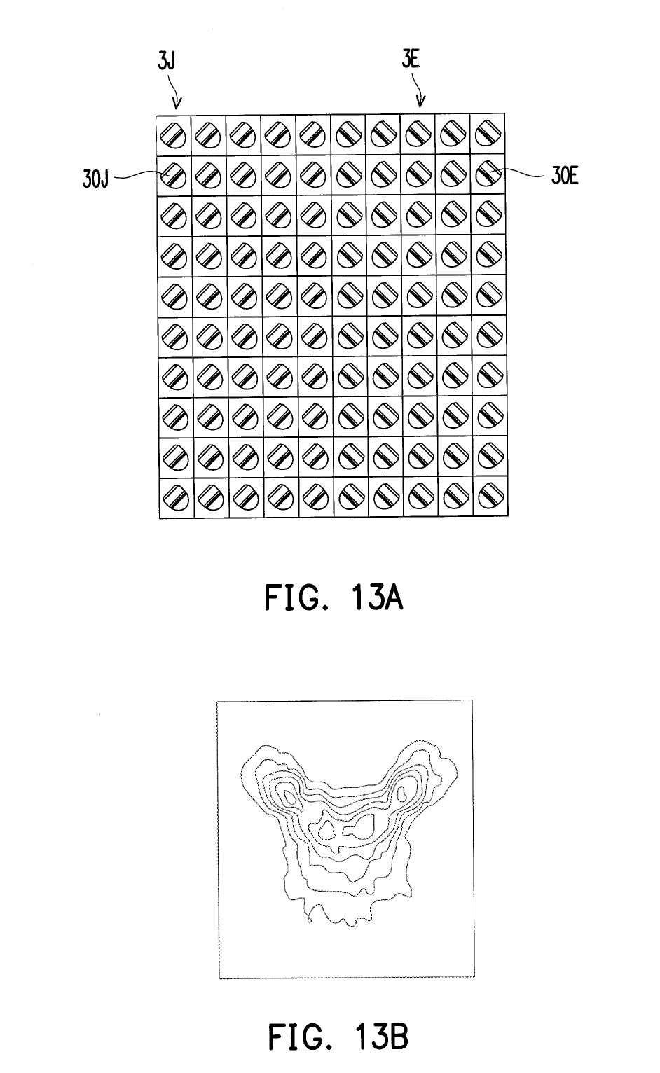

Referring to FIGS. 13A and 13B, FIG. 13A is a schematic view of a light action element module arrangement producing a V-shaped light shape according to an exemplary embodiment. FIG. 13B schematically illustrates the V-shaped light shape produced by the embodiment depicted in FIG. 13A. In the depicted arrangement of the light action element module in the lighting device, the five columns near the left side of FIG. 13A adopt the light action element module 3J formed by 10 lenses with oblique (−45°) asymmetric light shapes (e.g. the light action elements 30J), and the five columns near the right side of FIG. 13A adopt the light action element module 3E formed by 10 lenses with oblique (45°) asymmetric light shapes (e.g. the light action elements 30E). Moreover, each light action element module 3J forms a combination of light action elements without separating, and each light action element module 3E forms another combination of light action elements without separating. The combinations of light action elements are pieced together to form a combination group of light action elements, for example, pieced together into an entire surface to form the combination group of light action elements. The light action element module 3J produces an asymmetric rectangular light shape at an oblique −45° angle, and the light action element module 3E produces an asymmetric rectangular light shape at an oblique 45°angle, so that the lighting device can generate the V-shaped light shape shown in FIG. 13B.

Besides the cross, X, T, L, V, line and circle, and cross and circle shapes, the lighting device of the present embodiment may also generate many more possible variations of light shapes, and the embodiments are not limited thereto. For example, by adding circular lenses (e.g. the light action elements 30G) into the light action element module arrangements for the cross light shape and the X-shaped beam, a circular light shape is produced at the intersection of the light shapes.

When the quantity of light emitting elements 12 is more, different lens arrays may be formed by different types of lenses, so that the entire lighting device can produce various kinds of light shapes.

Moreover, in the aforementioned light action element module arrays producing different light shapes, the same light action element module is arranged in each column. In practice, the structure in the present embodiment may, according to illumination requirements, combine different types of lenses in the same column, so as to produce various kinds of light shapes and to satisfy the illumination requirements. For example, the light action elements 30H (i.e. reflective cups) may be added to adjust an exit angle of light, or the light action elements 30I (i.e. diffusive covers) may be added to diffuse and even the light, or to spread out light shape edges and soften the light shape.

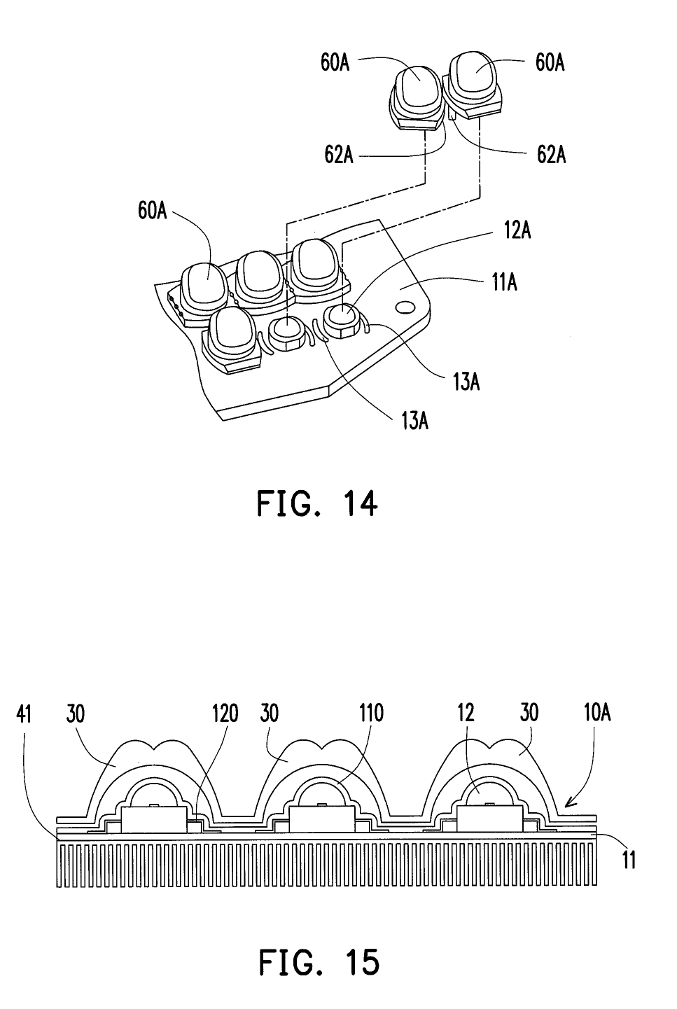

Referring to FIG. 14 depicting another embodiment, one of a mutually engaging first positioning part 13A and a second positioning part 62A is a curved hole around the corresponding light emitting element 12A. The other one of the mutually engaging first positioning part 13A and the second positioning part 62A is an inserting pin suitable to move in the curved hole, so the light action elements 60A rotate with respect to the corresponding light emitting element 12A. In the present embodiment, two opposing curved holes located on a carrier 11A are disposed around each light emitting element 12A, and two corresponding inserting pins are disposed in a bottom of each light action element 60A. An angle of the light shape may be adjusted by rotating the light action elements 60A with respect to the light emitting elements 12A, and therefore the effect of light shape adjustment described in the embodiments illustrated in FIG. 2 and FIGS. 4-12 can be achieved.

FIG. 15 is a schematic cross-sectional view depicting a light source module and a light action element in a lighting device according to still another exemplary embodiment. The lighting device of the present embodiment is similar to the embodiment illustrated in FIG. 2, and a difference therebetween is that, a light source module 10A further includes a waterproof element 110 disposed between the carrier 11 and the light action elements 30. In FIG. 15, the waterproof element 110 covers the carrier 11 and the light emitting elements 12, for example. In the present embodiment, the waterproof element 110 is, for example, a waterproof layer. After the waterproof layer is first coated or sprayed on the light emitting elements 12, the light action elements 30 are then disposed on the light emitting elements 12 and the waterproof layer. Since the lighting device of the present embodiment has the waterproof element 110, a waterproof effect can be achieved without adopting the transparent cover 52. Moreover, in other embodiments, the waterproof layer may not need to cover the entire light emitting elements 12 and the carrier 11, but only cover the conductive leads 120 of the light emitting elements 12 and the bonding pads electrically contacted with the conductive leads 120.

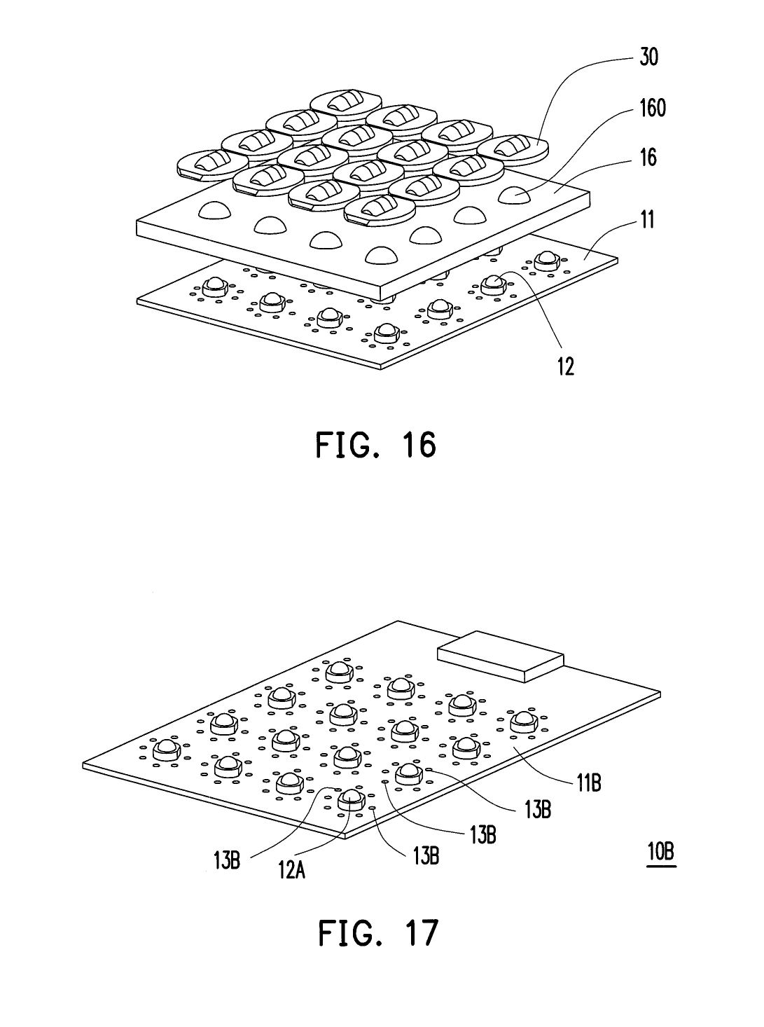

FIG. 16 is a three-dimensional view depicting a light source module and a light action element module in a lighting device according to another exemplary embodiment. Referring to FIG. 16, the lighting device of the present embodiment is similar to the lighting device of the embodiment illustrated in FIG. 15, and a difference therebetween is that, in the present embodiment, a waterproof element 16 is, for example, a waterproof cover covering the light emitting elements 12 and the carrier 11, and the light action elements 30 are disposed on and cover the protrusions 160 on the waterproof element 16.

FIG. 17 is a three-dimensional view depicting a light source module in a lighting device according to another exemplary embodiment. The lighting device of the present embodiment is similar to the lighting device of the embodiment illustrated in FIG. 14, and the differences therebetween are described hereafter. In the present embodiment, a carrier 11B of a light source module 10B includes at least a pair of first positioning parts 13B (e.g., a plurality of pairs of the first positioning parts 13B are shown in FIG. 17). The two first positioning parts 13B in each pair of first positioning parts 13B are respectively disposed on two sides of the light emitting elements 12A (e.g., on two opposing sides, although not limited thereto in the disclosure, in other embodiments, may also be on two adjacent sides or on two sides in different orientations). The pairs of first positioning parts 13B surrounds the light emitting elements 12A. In the present embodiment, a pair of second positioning parts (e.g. the second positioning parts 62A in FIG. 14) is disposed on two opposing sides of the bottom of the light action elements (e.g. the light action elements 60A in FIG. 14). In the present embodiment, the first positioning parts 13B are insertion holes and the second positioning parts 62A are inserting pins, for example. The pair of second positioning parts 62A of the light action elements 60A may be selectively inserted in different pairs of first positioning parts 13B, so that the light action elements 60A has different configured angles. Accordingly, a rotation effect similar to the light action elements 60A depicted in FIG. 14 can be achieved, so as to provide different light shapes.

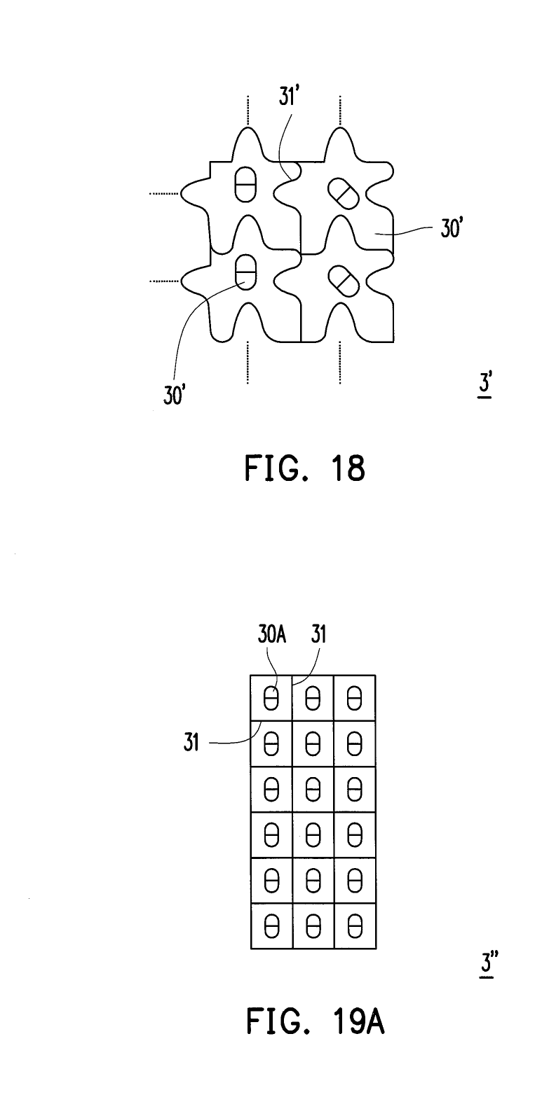

FIG. 18 is a schematic top view of a light action element module according to another exemplary embodiment. Referring to FIG. 18, a light action element module 3′ is similar to the light action element modules 3A and 3C depicted in FIG. 6, and a difference therebetween is that, in the present embodiment, a detachable section 31′ of the light action element module 3′ is curved. In other words, the detachable section 31′ is a curved boundary. Therefore, the light action elements 30′ separated along the curved detachable section 31 may be pieced together with other light action elements 30′ having different light action properties.

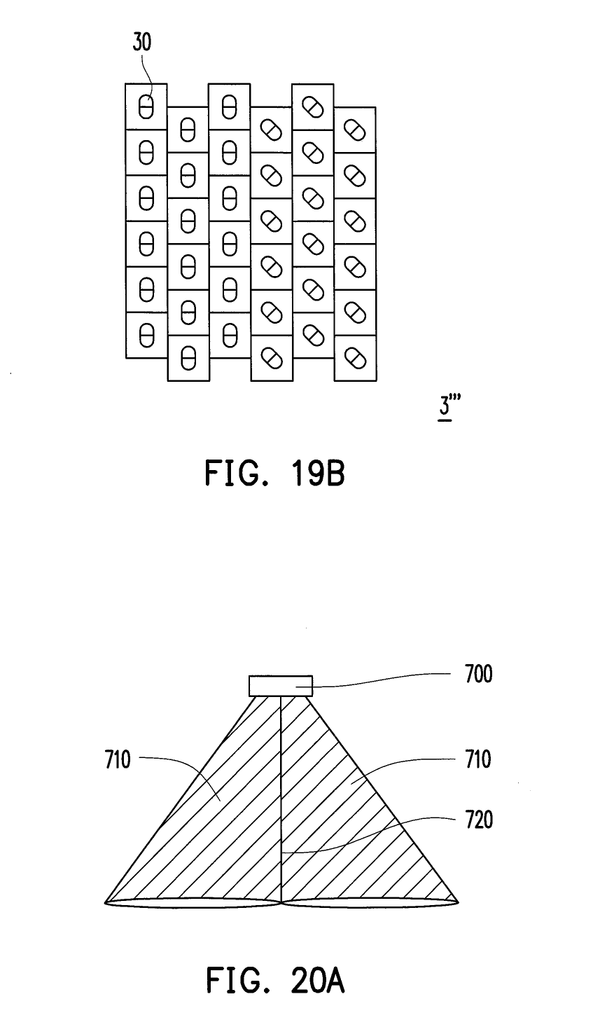

FIG. 19A is a schematic top view of a light action element module according to another exemplary embodiment. Referring to FIG. 19A, a light action element module 3″ of the present embodiment is similar to the light action element module 3A depicted in FIG. 6, and a difference therebetween is in that, the light action elements 30A of the light action element module 3A are arranged in N×1 arrays (shown as 10×1 arrays in FIG. 19A), whereas the light action elements 30A of the light action element module 3″ in FIG. 19A are arranged in N×K arrays, in which K>1, and as an example in FIG. 19A, K=3. According to usage requirements, the light action element module 3″ may be separated into a plurality of combinations of light action elements along at least a part of the detachable sections 31. Moreover, the combinations of light action elements may be pieced together, or pieced together with combinations having other types of light action elements according to usage requirements.

FIG. 19B is a schematic top view of a light action element module according to another exemplary embodiment. A light action element module 3′″ of the present embodiment is similar to the light action element module 3″ depicted in FIG. 19A, and a difference therebetween is in that, the light action elements 30 of the light action element module 3′″ are arranged in a staggered way. Moreover, according to usage requirements, after the light action element module 3′ is separated into a plurality of combinations of light action elements, the combinations of light action elements may be pieced together in an staggered arrangement, or pieced together with combinations having other types of light action elements. The disclosure does not limit the arrangement of the light action elements 30 to an array or a staggered arrangement. In other embodiments, any other suitable arrangements may be adopted. Furthermore, the light emitting elements below the light action elements may also be arranged in any suitable manner.

FIG. 20A is a schematic view of an illumination from a lighting device with a symmetric light shape. FIG. 20B is a schematic view of an illumination from a light emitting element and a light action element according to an exemplary embodiment. Referring to FIGS. 20A and 20B, an illumination beam 710 formed by a lighting device 700 with symmetric light shapes has a symmetric light shape left to right, and uniform illumination is formed on two sides of a center axis 720 of the lighting device 700. FIG. 20B illustrates a light emitting element 810 in one embodiment adapted to emit a beam 812. The light action element 820 of the present embodiment is disposed on a transmission path of the beam 812, so the beam 812 deviates towards one side of an optical axis 814 of the light emitting element 810 to form asymmetric illumination.

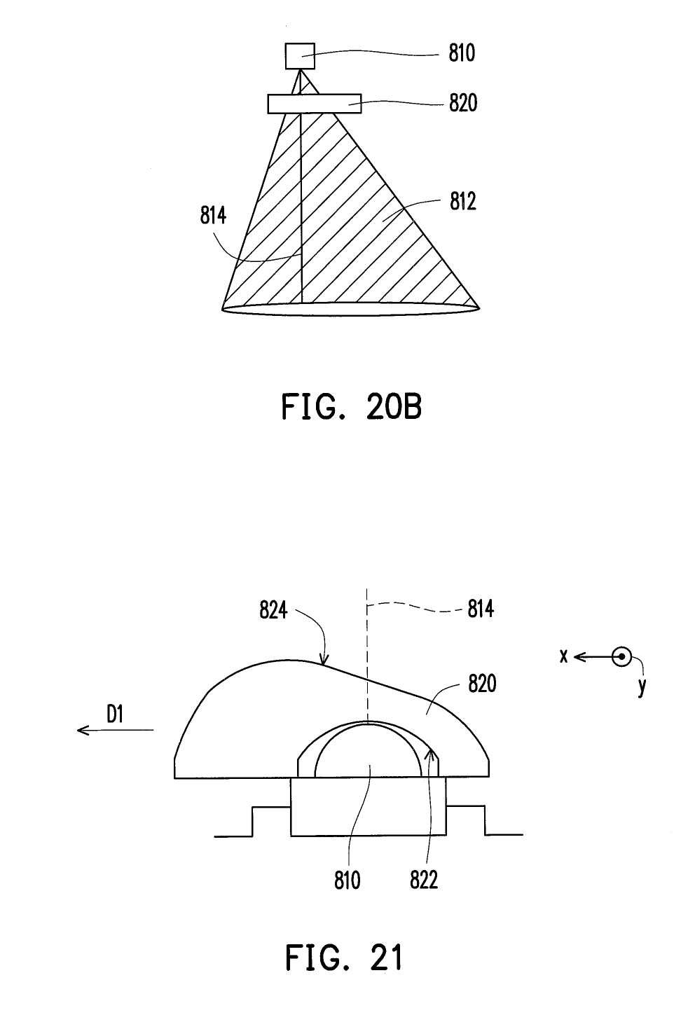

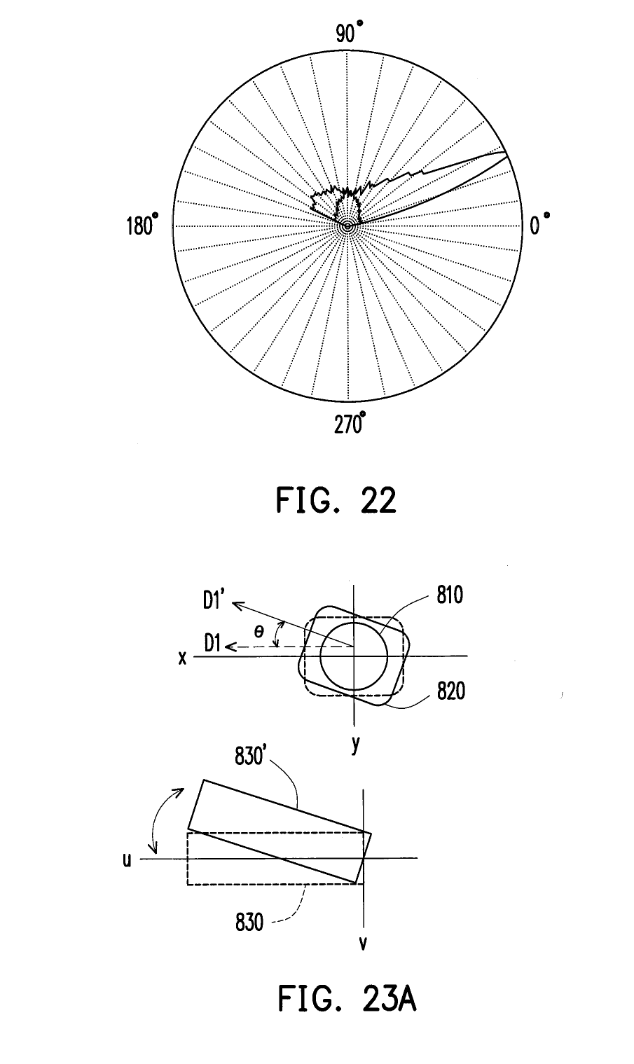

FIG. 21 is a schematic cross-sectional view of the light emitting element and the light action element depicted in FIG. 20B, and FIG. 22 is a light distribution diagram generated by the light emitting element and the light action element depicted in FIG. 21. Referring to FIGS. 21 and 22, the light emitting element 810 is an LED, and the light action element 820 is an asymmetric lens, for example. The light action element 820 corresponds to the light emitting element 810 to guide the light emitted from the light emitting element 810. Each light action element 820 has an asymmetric curved surface (i.e. light exiting surface 824), and the light action element 820 has at least one mirror-asymmetric cross-section (e.g. the cross-section depicted in FIG. 21) in an asymmetric direction D1. Specifically, the light action element 820 has a light incident surface 822 and a light exiting surface 824 opposite to the light incident surface 822. In the present embodiment, the light incident surface 822 is axial symmetric with respect to the optical axis 814 of the light emitting element 810. However, the light exiting surface 824 is mirror-asymmetric in the asymmetric direction D1 (i.e. a direction parallel to the x direction), which is to say, the light exiting surface 824 is asymmetric left to right.

As shown in FIG. 22, the light shape produced by the light emitting element 810 and the light action element 820 is an asymmetric light shape in the x direction (i.e. direction D1), in which the physical quantity represented by the radial direction in FIG. 22 is illuminance, and the circumferential direction represents the angle.

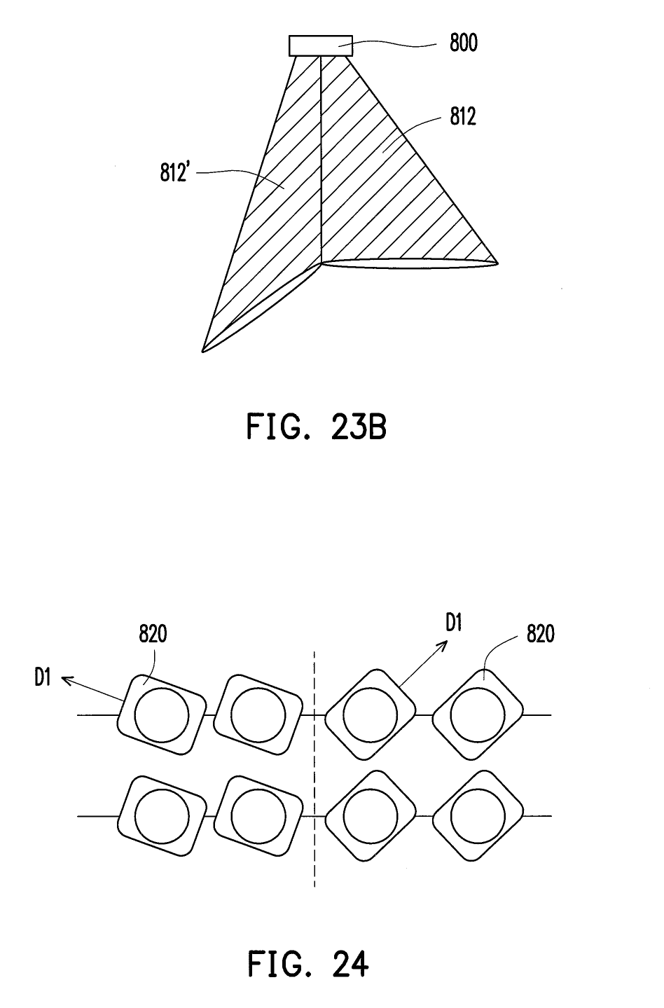

FIG. 23A and FIG. 23B illustrate applications of the light emitting element and the light action element depicted in FIG. 21. Referring to FIGS. 23A and 23B, the light action element 820 of the present embodiment is adapted to rotate with respect to the light emitting element 810. In FIG. 23, before the light action element 820 rotates, the asymmetric direction D1 is parallel to the x direction. At this time, an illumination light shape 830 produced by the light emitting element 810 and the light action element 820 is represented by a dotted rectangle shown in FIG. 23A. When the light action element 820 rotates by an angle θ with respect to the light emitting element 810, i.e. the asymmetric direction rotates from D1 to D1′, an illumination light shape 830′ produced by the light emitting element 810 and the light action element 820 also rotates along, in which the uv coordinate is the coordinate of the illumination light shape, and u is parallel to x, and v is parallel to y. As shown in FIG. 23B, when the lighting device 800 has two sets of light emitting elements 810 and light action elements 820, and the asymmetric direction D1 of the two sets of light action elements 820 is oriented towards different directions, a beam 812 and a beam 812′ are respectively generated to produce a L-shaped illumination. For example, FIG. 24 schematically illustrates the asymmetric directions D1 of two sets of light action elements 820 respectively being oriented towards two different directions. In other embodiments, three or more sets of light action elements 820 may be adopted, and the asymmetric directions D1 thereof are respectively oriented towards three different directions.

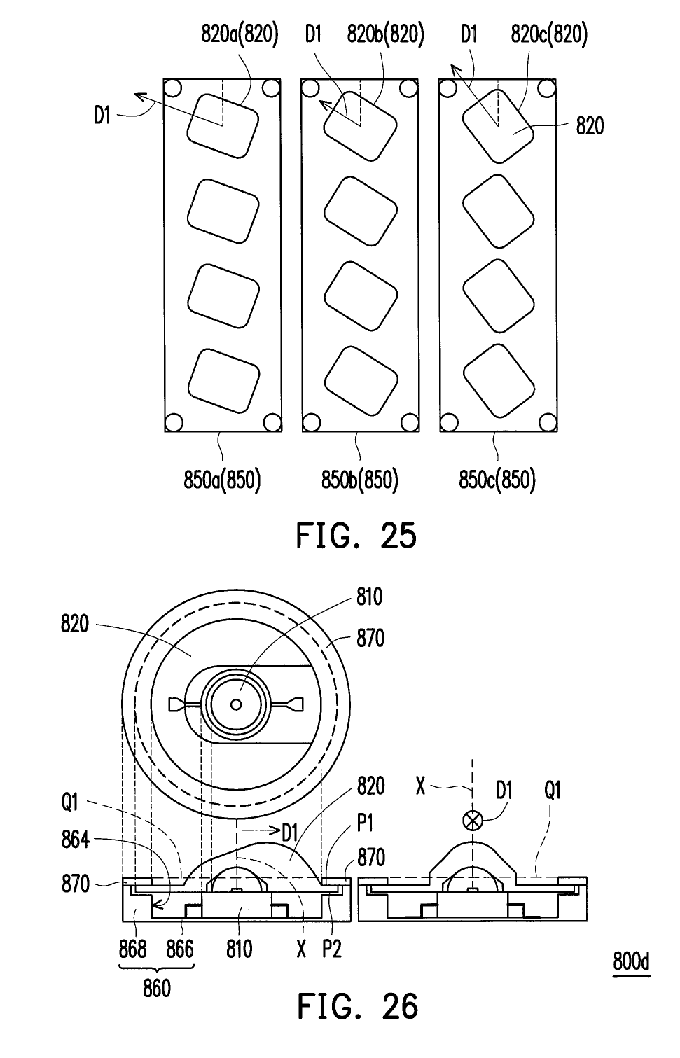

Besides adopting the method depicted in FIG. 24 to produce the L-shaped illumination, in another embodiment illustrated in FIG. 25, the principle of the light action element module 3 of FIG. 2 may be adopted. That is to say, a plurality of light action elements 820 may be connected to form a light action element module 850. For example, a plurality of light action elements 820a may be connected to form a light action element module 850a, a plurality of light action elements 820b may be connected to form a light action element module 850b, and a plurality of light action elements 820c may be connected to form a light action element module 850c. The asymmetric directions D1 of the light action elements 820a, 820b, and 820c are respectively oriented towards three different directions, and therefore a three-fork light shape can be produced.

FIG. 26 depicts a schematic cross-sectional view and a top view of two perpendicular cross-sections of a lighting device according to an exemplary embodiment. Referring to FIG. 26, a lighting device 800d of the present embodiment includes the light action element 820, the above-mentioned light emitting element 810, a carrier 860, and a fastening cover 870. The light emitting element 810 is disposed on the carrier 860. The carrier 860 includes a heat dissipating substrate 866. In another embodiment, a bottom of the carrier 860 may also have heat sink wings to aid the heat dissipation. Moreover, in the present embodiment, the carrier 860 has a recess 864 to contain the light emitting element 810. To be specific, in the present embodiment, the carrier 860 may further include a supporting part 868 disposed on the heat dissipating substrate 866 and surrounding the recess 864. The supporting part 868 and the heat dissipating substrate 866 may be integrally formed, or may be formed separately and then assembled together. The fastening cover 870 fixes an edge of the light action element 820 on the carrier 860. For example, the edge of the light action element 820 is fixed on an edge of the recess 864 (i.e., fixed on the supporting part 868), so as to fix the light action element 820. The light emitting element 810 is disposed between the light action element 820 and the carrier 860. Moreover, a waterproof ring may be disposed between the fastening cover 870 and the edge of the light action element 820 (e.g., disposed at a position P1 in FIG. 26), or the waterproof ring may be disposed between the edge of the light action element 820 and a top part of the edge of the recess 864 (e.g., disposed at a position P2 in FIG. 26). Accordingly, when the fastening cover 870 is closed, the waterproof ring is pressurized, so that a space formed between the recess 864 and the light action element 820 achieves a waterproof or dust-proof effect, and thereby protects the light emitting element 810. Therefore, the lighting device 800d of the present embodiment can omit the transparent cover 52 depicted in FIG. 2. In the present embodiment, the light action element 820 is adapted to deflect a light emitted from the light emitting element 810 towards the asymmetric direction D1. Furthermore, the light action element 820 in the lighting device 800d is adapted to rotate with respect to the light emitting element 810, so as to adjust an orientation of the asymmetric direction D1 of the light action element 820. For example, the light action element 820 is adapted to rotate on a plane Q1 perpendicular to an optical axis X of the light emitting element 810. The optical axis X may be used as a rotational axis, for instance. Using FIG. 26 as an example, the light action element 820 may rotate on the plane Q1, so as to rotate the asymmetric direction D1 from pointing towards the right in the left side diagram of FIG. 26, to an orientation pointing into the diagram in the right side diagram of FIG. 26.

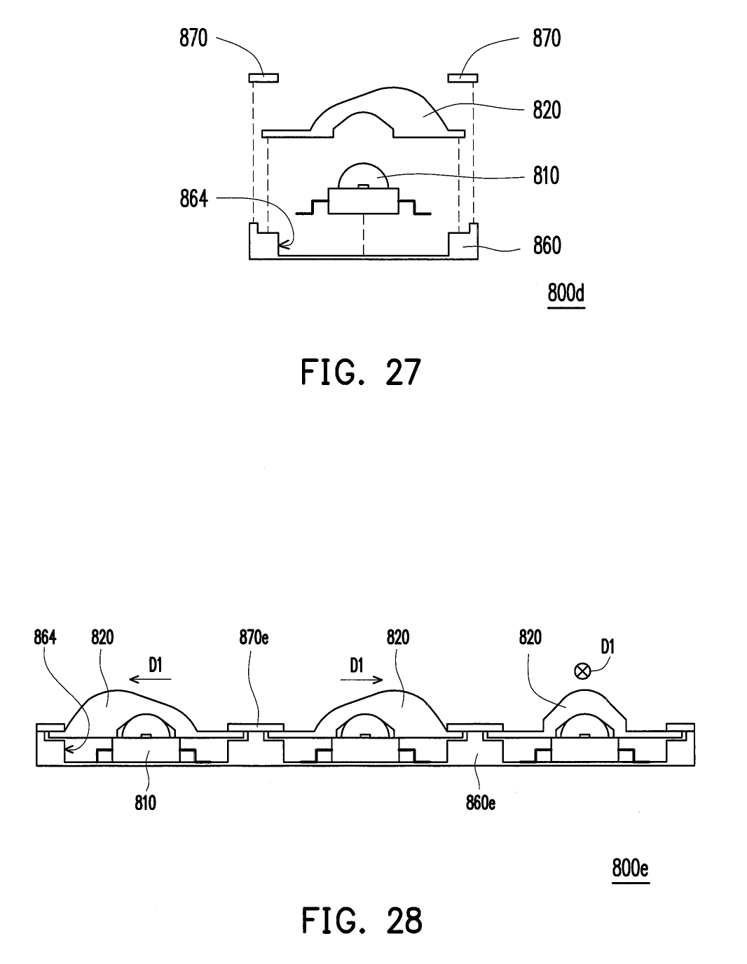

FIG. 27 is an exploded view of the lighting device depicted in FIG. 26. Referring to FIGS. 26 and 27, when the lighting device 800d is being assembled, the light emitting element 810 may be first disposed in the recess 864 of the carrier 860. Thereafter, after the light action element 820 is rotated to a suitable direction, the light action element 820 is used to cover the recess 864 and the light emitting element 810. Before this process, the waterproof ring may be disposed on the top part of the edge of the recess 864. Alternatively, the waterproof ring may be disposed on the edge of the light action element 820 after this process. Thereafter, the fastening cover 870 is used to fix the edge of the light action element 820 on the recess 864 to complete the assembly. In the present embodiment, after the assembly is complete, as long as the fastening cover 870 has a suitable elasticity, the light action element 820 can still rotate on the plane Q1 and thereby rotate the asymmetric direction D1.

FIG. 28 is a schematic cross-sectional view of a lighting device according to another exemplary embodiment. Referring to FIG. 28, a lighting device 800e is similar to the lighting device 800d in FIG. 26, and the differences therebetween are described hereafter. In the present embodiment, a carrier 860e of the lighting device 800e has a plurality of recesses 864 respectively containing a plurality of light emitting elements 810, and the light action elements 820 respectively covers the recesses 864 and the light emitting elements 810. Moreover, a fastening cover 870e fixes the edges of the light action elements 820 to fasten the light action elements 820. Before or after fixing the edges of the light action elements 820 with the fastening cover 870e, at least a part of the asymmetric directions D1 of the light action elements 820 may be first respectively rotated to different directions. When three light action elements 820 are rotated to three different directions as shown in FIG. 28, a T-shaped illumination light shape can be produced. By respectively rotating the light action elements 820 to different directions, illumination light shapes having “−”, “+”, “<”, and “L” shapes can be produced according to usage requirements.

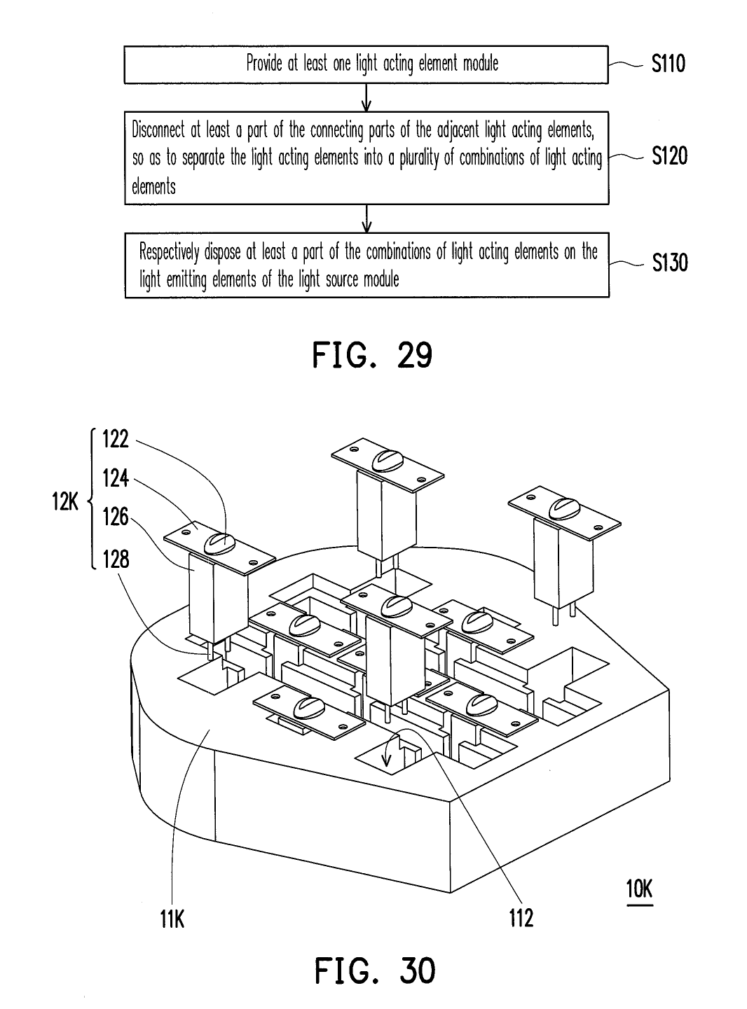

FIG. 29 is a flowchart of an assembly method of a lighting device according to an exemplary embodiment. Referring to FIGS. 2, 3, 6, and 29, the assembly method of the lighting device in the present embodiment may be used to assemble the lighting device of the foregoing embodiments. The assembly of the lighting device depicted in FIG. 2 is used as an illustrative example hereafter. The assembly method of the lighting device in the present embodiment includes the following steps. First, as shown in a Step S110, at least one light action element module 3 is provided. FIG. 6 provides a plurality of light action element modules 3A-3I, for example, in which the light action element module 3 has a plurality of light action elements 30 connected with each other (e.g. 30A-30I). Thereafter, as shown in a Step S120, at least a part of the connecting parts (e.g. detachable sections 31) of the adjacent light action elements 30 is disconnected, so as to separate the light action elements into a plurality of combinations 3S of light action elements (e.g. combinations 3S of light action elements illustrated in FIGS. 2 and 3 having 1, 2, 3, 7, etc. light action element(s) 30 of which the numbers are not all equal). In other words, each of the combinations 3S of light action elements has at least one light action element 30. As described in the foregoing embodiments, the light action elements 30 may be separated along the detachable sections 31 by breaking, cutting, splitting, sawing, trimming, or other suitable methods, so as to separate two adjacent light action elements 30. Thereafter, as shown in a Step S130, a light source module 10 is provided, and the combinations 3S of light action elements are disposed on the light emitting elements 12. The light action elements 30 correspond to the light emitting elements 12, in order to guide the light emitted from the light emitting elements 12. Description of the different types of detachable sections 31 may be referenced to earlier embodiments, and therefore further elaboration is omitted.

In the assembly method of the present embodiment, as well as the lighting device and the light action element module therein according to the foregoing embodiments, since the light action element module 3 may be uniformly fabricated into N×K quantities, therefore the fabrication process is uniform and cost can be lowered. Moreover, the fabrication process does not need to consider specific usage requirements. Furthermore, the light shape of the assembled lighting device may meet the specific usage requirements by separating a part of the adjacent light action elements 30 during assembly, forming different combinations 3S of light action elements, and piecing together the combinations 3S of different types of light action elements 30 on the light source module 10.

FIG. 30 is a three-dimensional view depicting a light source module in a lighting device according to another exemplary embodiment. Referring to FIG. 30, the lighting device of the present embodiment is similar to the lighting device 1 depicted in FIG. 2, and a difference therebetween is in a light source module 10K of the present embodiment compared to the light source module 10 of FIG. 2. In the light source module 10K of the present embodiment, a carrier 11K is a circuit board, for example, and a plurality of slots are established on the carrier 11K. Moreover, a light emitting element 12K includes an LED 122, an insertion part 126, a heat dissipation plate 124, and a plurality of electrodes 128. The LED 122 is disposed on an end of the insertion part 126, and this end is also connected to the heat dissipation plate 124. Moreover, the electrodes 128 are disposed at another end of the inserting part 126, and the electrodes 128 are electrically connected to the LED 122. In the present embodiment, the light emitting element 12K may be connected to the carrier 11K by direct extractable insertion. Specifically, the insertion part 126 of the light emitting element 12K is inserted into the slots 112 on the carrier 11K, and at this time the electrodes 128 are electrically connected to the electrodes on the carrier 11K. For example, the electrodes 128 are pillar electrodes adapted to be inserted in the electrical holes on the carrier 11K, so the LED 122 is electrically connected to the carrier 11K. Moreover, the two ends of the heat dissipation plate 124 lean against the edges of the slots 112. In the present embodiment, the heat dissipation plate 124 is connected to the LED 122, therefore heat generated by the LED 122 can be transferred by the heat dissipation plate 124 to the carrier 11K. When the LED 122 needs to be removed, the insertion part 126 can be directly pulled out of the slots 112. In other embodiments, the LED 122 may also be replaced with an organic LED (OLED) or a laser emitter.

The foregoing embodiments use a single lighting device forming a lighting system as examples. In the embodiment hereafter, a plurality of lighting devices forming a lighting system is used as an illustrative example.

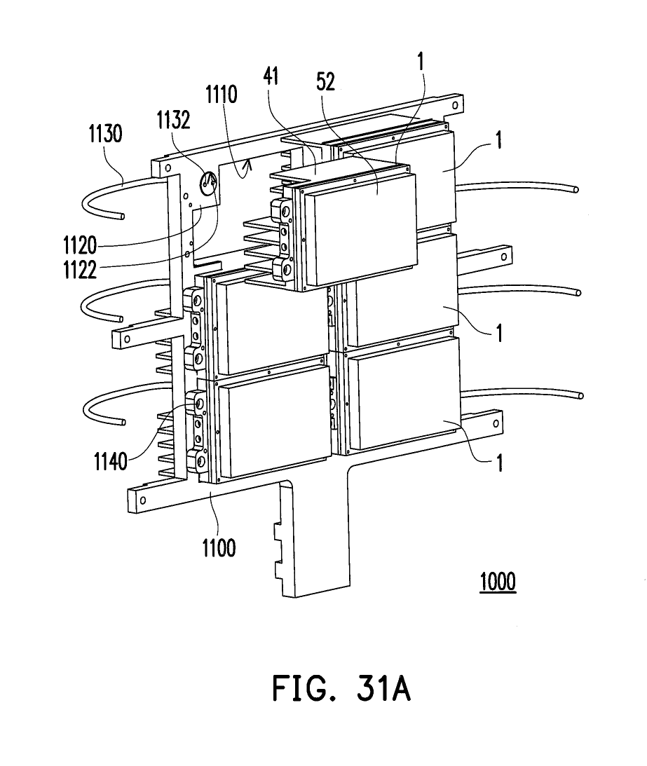

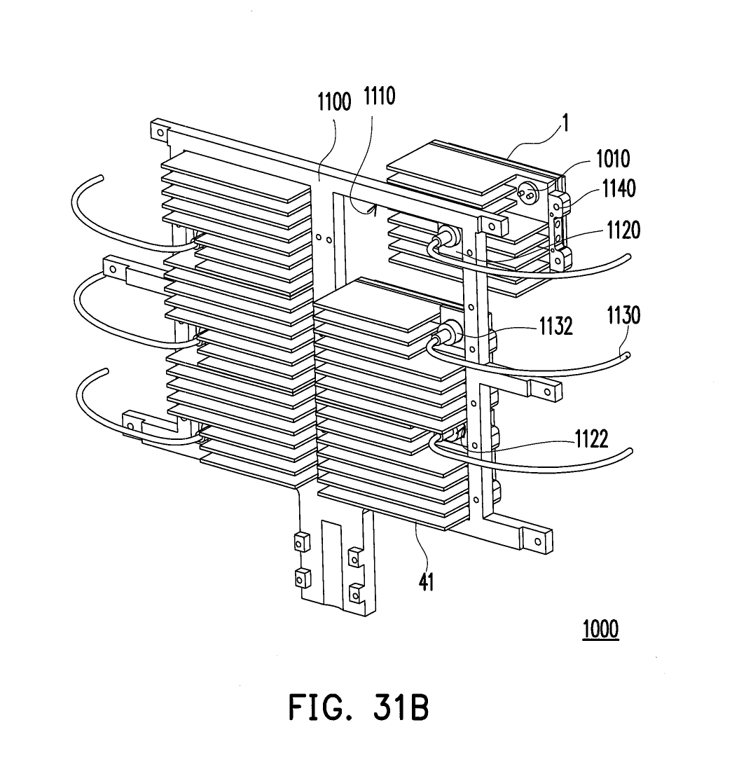

FIGS. 31A and 31B are respective three-dimensional views of a lighting system at two different view angles according to an exemplary embodiment. Referring to FIG. 31A and FIG. 31B, a lighting system 1000 of the present embodiment includes a plurality of lighting devices 1, a supporting element 1100, and a plurality of fastening elements 1140. The supporting element 1100 is, for example, a supporting frame for supporting the lighting devices 1. In the present embodiment, the supporting element 1100 includes a plurality of accommodating openings 1110 respectively containing the lighting devices 1, such as for containing a heat sink wings 41 of the lighting devices 1. The fastening elements 1140 respectively fix the lighting devices 1 on the supporting element 1100. In the present embodiment, the fastening elements 1140 are connected to the heat sink wings 41 of the lighting devices 1, for example, although the disclosure is not limited thereto. In other embodiments, the fastening elements 1140 may be connected to other parts of the lighting devices 1. In the present embodiment, the fastening elements 1140 are locked on the lighting devices 1 with screws. However, in other embodiments, the fastening elements 1140 may be bonded on the lighting devices 1 with tenons, or fixed on the lighting devices 1 by other suitable methods. Moreover, in the present embodiment, the fastening elements 1140 are bonded on the supporting element 1100 with tenons. However, in other embodiments, the fastening elements may be locked on the supporting element 1100 with screws, or fixed on the supporting element 1100 by other suitable methods.

In the present embodiment, the lighting system 1000 further includes a plurality of power connectors 1130 respectively electrically connected to the lighting devices 1 to respectively provide power to the lighting devices 1. For example, the power connectors 1130 are power cables having one end connected to an external power source, and another end connected to the lighting devices 1 to provide power thereto.

In the present embodiment, each power connector 1130 has a first connector 1132, and each lighting device 1 includes a second connector 1010 electrically connected to the light emitting elements 12 (depicted in FIG. 3). The first connectors 1132 are adapted to respectively connect to the second connectors 1010, so the power connectors 1130 are respectively electrically connected to the lighting devices 1. In the present embodiment, the first connectors 1132 are female connectors, and the second connectors 1010 are male connectors. However, in other embodiments, the first connectors 1132 may also be male connectors, whereas the second connectors 1010 are female connectors.

In the present embodiment, the supporting element 1100 may have a plurality of connector fasteners 1120 each having a through hole 1122 to contain the first connectors 1132. Therefore, the first connectors 1132 may be first fixed in the through holes 1122, and when the lighting devices 1 are disposed in the accommodating openings 1110, the second connectors 1010 become naturally connected to the first connectors 1132. The lighting system 1000 of the present embodiment can thus achieve an effect of simply and conveniently connecting a plurality of lighting devices 1 together.

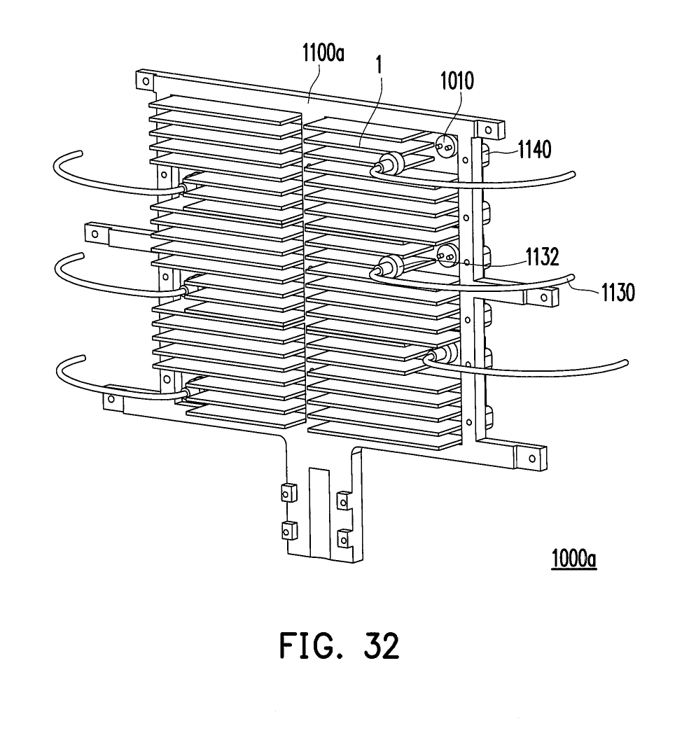

FIG. 32 is a three-dimensional view of a lighting system according to another exemplary embodiment. Referring to FIG. 32, a lighting system 1000a of the present embodiment is similar to the lighting systems depicted in FIGS. 31A and 31B. The dissimilarities are described below. In the lighting system 1000a of the present embodiment, a supporting element 1100a does not have the connector fasteners 1120 depicted in FIG. 31A. After the lighting devices 1 are fixed on the supporting element 1100a, the first connectors 1132 are connected to the second connectors 1010. Accordingly, the first connectors 1132 are fixed to the second connectors 1010, and therefore the connector fasteners 1120 of FIG. 31A are not needed to fix the first connectors 1132.

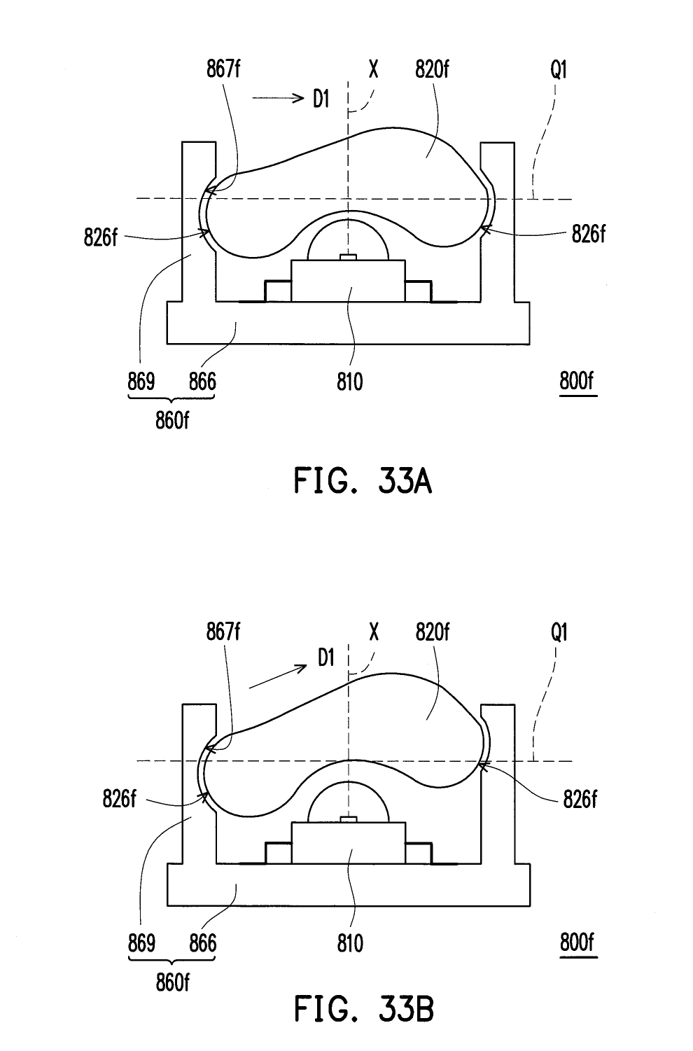

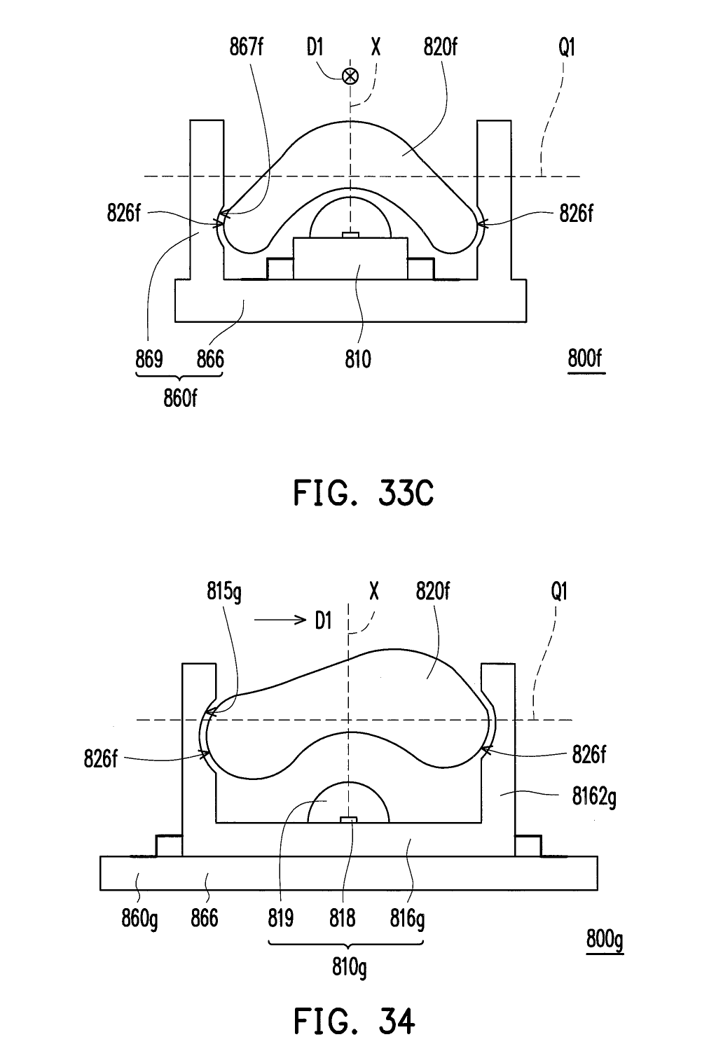

FIGS. 33A-33C are schematic cross-sectional views of a lighting device under three different states according to another exemplary embodiment. Referring to FIG. 33A-33C, a lighting device 800f is similar to the lighting device 800d illustrated in FIG. 26, and the differences therebetween are described hereafter. In the lighting device 800f of the present embodiment, a carrier 860f has a supporting part 869, and an edge of a light action element 820f is lodged at an inner side of the supporting part 869, thereby forming a universal joint with the supporting part 869. In the present embodiment, the supporting part 869 is a ring-shaped supporting part, for example. In other words, the light action element 820f is adapted to rotate on a plane including an optical axis X of the light emitting element 810 (e.g., on the planes of the drawings in FIGS. 33A-33C, or other planes including the optical axis X). For example, the light action element 820f may rotate from the state depicted in FIG. 33A to the state depicted in FIG. 33B, so that an asymmetric direction D1 rotates from the state depicted in FIG. 33A to the state depicted in FIG. 33B. That is to say, in the present embodiment, the light action element 820f is adapted to rotate around any line, serving as a rotational axis, perpendicular to the optical axis X. When this line passes through a geometric center of the light action element 820f, the motion of the light action element 820f resembles spins, and when this line deviates from the geometric center of the light action element 820f, the motion of the light action element 820f resembles revolutions. In FIG. 33B, the asymmetric direction D1 tilts with respect to the heat dissipating substrate 866 of the carrier 860f, so that the light shape of the lighting device 800f can have more variations. In addition, the light action element 820f may also rotate on a plane Q1 perpendicular to the optical axis X, for example by rotating from the state depicted in FIG. 33A to the state depicted in FIG. 33C. The optical axis X may be used as a rotational axis, for instance. In the present embodiment, the edge of the light action element 820f has an arc-shaped surface 826f. An inner side the supporting part 869 has a recess 867f (e.g. arc-shaped recess) to contain the arc-shaped surface 826f. The arc-shaped surface 826f may slide relative to the recess 867f, and accordingly the edges of the light action element 820f and the supporting part 869 can form a universal joint.

FIG. 34 is a schematic cross-sectional view of a lighting device according to another exemplary embodiment. Referring to FIG. 34, a lighting device 800g of the present embodiment is similar to the lighting device 800f depicted in FIG. 33A. The dissimilarities are described below. In the lighting device 800g of the present embodiment, a light emitting element 810g includes a light emitting chip 818, a base 816g, and a transparent encapsulant 819. The light emitting chip 818 is an LED chip, for example. The base 816g carries the light emitting chip 818, in which an edge of the light action element 820f may rotatably connect to the base 816g. Moreover, in the present embodiment, the transparent encapsulant 819 wraps the light emitting chip 818.

In the present embodiment, the base 816g has a supporting part 8162g (e.g. ring-shaped supporting part), and the edge of the light action element 820f lodges on an inner side of the supporting part 8162g, and forms a universal joint with the supporting part 8162g. Specifically, the supporting part 8162g has a recess 815g (e.g. arc-shaped recess) to contain the arc-shaped surface 826f of the light action element 820f. The arc-shaped surface 826f may slide relative to the recess 815g, and accordingly the edge of the light action element 820f and the supporting part 8162g of the base 816g can form a universal joint.

In the present embodiment, the carrier 860g includes a heat dissipating substrate 866. The light emitting element 810g is carried by the heat dissipating substrate 866, and the light action element 820f is supported by the supporting part 8162g of the base 816g of the light emitting element 810g. In the present embodiment, the light action element 820f may rotate on a plane Q1 perpendicular to an optical axis X, and may rotate on any plane including the optical axis X.

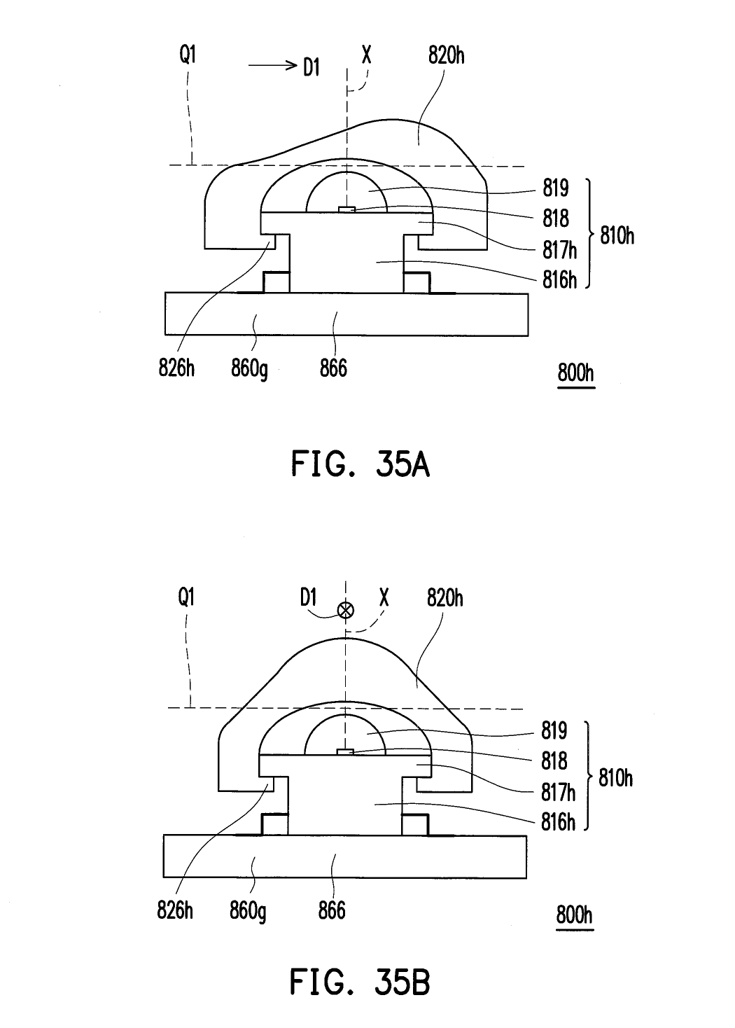

FIGS. 35A and 35B are schematic cross-sectional views of a lighting device under two different states according to another exemplary embodiment. Referring to FIG. 35A, a lighting device 800h of the present embodiment is similar to the lighting device 800g depicted in FIG. 34. The dissimilarities are described below. In the lighting device 800h of the present embodiment, a top part of a base 816h of the light emitting element 810h has a protrusion 817h (e.g., a ring-shaped flange, an arc-shaped protrusion, or a plurality of discontinuous protrusions). A bottom part of the light action element 820h has a hook 826h (e.g., a ring-shaped hook, an arc-shaped hook, or a plurality of discontinuous hooks), in which the hook 826h hooks the protrusion 817h. In the present embodiment, the hook 826h is adapted to slide relative to the protrusion 817h, and accordingly, the light action element 820h may rotate on a plane Q1 perpendicular to an optical axis X of the light emitting element 810h. For example, the light action element 820h may rotate from the state depicted in FIG. 35A to the state depicted in FIG. 35B, so that an asymmetric direction D1 rotates from a right pointing direction depicted in FIG. 35A to a direction pointing into the drawing as depicted in FIG. 35B.

In conclusion, according to the lighting system, lighting device, light action element, light action element module, and the assembly method thereof described in the foregoing embodiments, since the light emitting element module may be uniformly fabricated into N×K quantities, therefore the fabrication process is uniform and cost can be lowered. Moreover, the fabrication process does not need to consider specific usage requirements. Furthermore, the light shape of the assembled lighting device may meet the specific usage requirements by separating a part of the adjacent light action elements during assembly, forming different combinations of light action elements, and piecing together the combinations of the same type or different types of light action elements on the light source module. In addition, in the lighting device of the foregoing embodiments, the waterproof element is disposed between the combinations of light action elements and the light emitting elements, so as to protect the light emitting elements. Accordingly, a transparent cover is not required to dispose above the light emitting elements, thereby saving material costs. Moreover, in the lighting device of the foregoing embodiments, light action elements with asymmetric light shapes are adopted, and they can rotate with respect to the light emitting elements to produce different light shapes. Therefore, the lighting device can provide suitable light shapes in accordance with different needs.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A light action element module, comprising:
N×K light action elements, wherein adjacent light action elements are connected, one or more detachable section(s) is/are disposed between the connected light action elements, the light action elements are for selection to separate into a plurality of combinations of the light action elements along at least a part of the detachable section(s) or to form a combination of the light action elements without separating, so as to piece together at least a part of the combinations of the light action elements in different manners, N and K are positive integers, and N is greater than or equal to 2.

2. The light action element module as claimed in claim 1, wherein the light action elements comprise lenses.

3. The light action element module as claimed in claim 2, wherein the lenses are lenses with symmetric light shape or lenses with asymmetric light shape.

4. The light action element module as claimed in claim 1, wherein the light action elements comprise at least one of reflective cups, diffusive covers, diffractive elements, and liquid lenses.

5. A lighting system, comprising:
at least one lighting device, comprising:
at least one light source module, wherein each of the light source modules comprises at least one light emitting element; and
at least one combination group of light action elements formed by at least a part of at least one light action element module, the light action element module comprising:
N×K light action elements, wherein adjacent light action elements are connected, one or more detachable section(s) is/are disposed between the connected light action elements, the light action elements are for selection to separate into a plurality of combinations of the light action elements along at least a part of the detachable section(s) or to form a combination of the light action elements without separating, whereby at least a part of the combinations of light action elements are pieced together in different manners, so as to form the combination groups of light action elements, N and K are positive integers, and N is greater than or equal to 2,
wherein the light action elements correspond to the light emitting elements so as to guide light emitted by the light emitting elements.

6. The lighting system as claimed in claim 5, wherein the light emitted by each of the light emitting elements is guided by at least one of the light action elements.

7. The lighting system as claimed in claim 5, wherein each of the light action elements guides the light emitted by at least one of the light emitting elements.

8. The lighting system as claimed in claim 5, wherein the light source module further comprises a carrier, and the light emitting elements are disposed on the carrier.

9. The lighting system as claimed in claim 8, wherein the light source module further comprises a waterproof element covering at least one of the carrier and the light emitting elements, and the waterproof element is disposed between the carrier and the light action elements.

10. The lighting system as claimed in claim 9, wherein the waterproof element is a waterproof layer or a waterproof cover.

11. The lighting system as claimed in claim 8, wherein the light emitting elements are connected to the carrier by direct extractable insertion.

12. The lighting system as claimed in claim 8, wherein the carrier has at least one first positioning part respectively disposed besides each of the light emitting elements, each of the light action elements has at least one second positioning part corresponding to the first positioning part, and the first positioning part and the second positioning part engage with each other, so that the light action elements are disposed across the corresponding light emitting elements.

13. The lighting system as claimed in claim 12, wherein one of the first positioning part and the second positioning part engaging with each other is an inserting pin, and the other one of the first positioning part and the second positioning part engaging with each other is an inserted hole.

14. The lighting system as claimed in claim 5, wherein the light emitting elements are light emitting diodes, organic light emitting diodes, or laser emitters.

15. The lighting system as claimed in claim 5, wherein the light action elements comprise lenses.

16. The lighting system as claimed in claim 15, wherein the lenses are lenses with symmetric light shape or lenses with asymmetric light shape.

17. The lighting system as claimed in claim 5, wherein the light action elements comprise at least one of reflective cups, diffusive covers, diffractive elements, and liquid lenses.

18. The lighting system as claimed in claim 5, wherein the lighting device further comprises a heat dissipating element connected to the light source module.

19. The lighting system as claimed in claim 18, wherein the heat dissipating element comprises a heat sink fins.

20. The lighting system as claimed in claim 5, wherein the lighting device further comprises a transparent cover covering the combination groups of light action elements.

21. The lighting system as claimed in claim 20, wherein the transparent cover has optical structures.

22. The lighting system as claimed in claim 5, wherein the at least one lighting device is a plurality of lighting devices, and the lighting system further comprises:
a supporting element configured to support the lighting devices; and
a plurality of fastening elements respectively fixing the lighting devices on the supporting element.

23. The lighting system as claimed in claim 22, further comprising:
a plurality of power connectors respectively electrically connected to the lighting devices in order to respectively provide power to the lighting devices.

24. The lighting system as claimed in claim 23, wherein each of the power connectors has a first connector, each of the lighting devices comprises a second connector electrically connected to the light emitting elements of the lighting devices, and the first connectors respectively connects to the second connectors, so that the power connectors are respectively electrically connected to the lighting devices.

25. A lighting device, comprising:
at least one light source module comprising at least one light emitting element;
at least one combination group of light action elements disposed on the light source module and having a plurality of light action elements, wherein the light action elements correspond to the light emitting elements, so as to guide light emitted by the light emitting elements; and
a waterproof element disposed between the light source module and the combination group of light action elements, and covering at least a part of the light source module.

26. The lighting device as claimed in claim 25, wherein the combination group of light action elements are formed by at least a part of at least one light action element module, the light action element module comprising:
N×K light action elements, wherein adjacent light action elements are connected, one or more detachable section(s) is/are disposed between the connected light action elements, the light action elements are for selection to separate into a plurality of combinations of the light action elements along at least a part of the detachable section(s) or to form a combination of the light action elements without separating, whereby at least a part of the combinations of light action elements are pieced together in different manners, so as to form the combination groups of light action elements, N and K are positive integers, and N is greater than or equal to 2.

27. The lighting device as claimed in claim 25, wherein the waterproof element is a waterproof layer.

28. The lighting device as claimed in claim 27, wherein the light source module has a carrier, each of the light emitting elements has two conductive leads, the light emitting elements are respectively electrically connected with bonding pads of the carrier respectively through the conductive leads, and the waterproof layer covers the conductive leads and the bonding pads.

29. The lighting device as claimed in claim 25, wherein the waterproof element is a waterproof cover.

30. The lighting system as claimed in claim 25, wherein the light source module further has a carrier, the light emitting elements are disposed on the carrier, and the waterproof element covers the light emitting elements and the carrier.

31. An lighting device, comprising:
at least one light emitting element; and
at least one light action element disposed on the light emitting element, wherein the light action element corresponds to the light emitting element in order to guide light emitted from the light emitting element, the light action element has asymmetric curved surface, and at least one cross-section of the light action element in an asymmetric direction is mirror-asymmetric,
wherein the light action element in the lighting device is adapted to rotate with respect to the light emitting element, so as to adjust an orientation of the asymmetric direction of the light action element.

32. The lighting device as claimed in claim 31, further comprising:
a carrier, wherein the light emitting element are disposed on the carrier; and
a fastening cover fixing an edge of the light action element on the carrier, wherein the light emitting element are disposed between the light action element and the carrier.

33. The lighting system as claimed in claim 31, wherein the light action element is adapted to rotate on a plane perpendicular to an optical axis of the light emitting elements.

34. The lighting system as claimed in claim 31, wherein the light action element is adapted to rotate on a plane including an optical axis of the light emitting element.

35. The lighting device as claimed in claim 31, wherein the light emitting element comprises:
a light emitting chip; and
a base carrying the light emitting chip, wherein an edge of the light action element is rotatably connected to the base.

36. The lighting device as claimed in claim 35, wherein the base has a supporting part, the edge of the light action element lodged on an inner side of the supporting part and forming a universal joint with the supporting part.

37. The lighting device as claimed in claim 35, wherein a top part of the base has a protrusion, and a bottom part of the light action element has a hook hooking the protrusion, and the light action element is adapted to rotate on a plane perpendicular to an optical axis of the light emitting element.

38. The lighting device as claimed in claim 31, further comprising a carrier, wherein the light emitting element is disposed on the carrier and between the light action element and the carrier, the carrier has a supporting part, and the edge of the light action element is lodged on an inner side of the supporting part and forms an universal joint with the supporting part.
